(19) United States
(12) Patent Application Publication
(10) Pub. No.: US 2018/0239563 A1
(43) Pub. Date: Aug. 23, 2018

(54) IMAGE FORMING APPARATUS, INFORMATION PROCESSING SYSTEM, AND METHOD FOR IMAGE FORMING APPARATUS AND TERMINAL DEVICE TO COMMUNICATE

(71) Applicant: Konica Minolta, Inc., Tokyo (JP)

(72) Inventors: Yuta OKUDA, Nagoya-shi (JP); Hao LUO, Amagasaki-shi (JP)

(21) Appl. No.: 15/895,483

(22) Filed: Feb. 13, 2018

(30) Foreign Application Priority Data
Feb. 17, 2017 (JP) 2017-028127
Mar. 8, 2017 (JP) 2017-043777
Mar. 23, 2017 (JP) 2017-057636

(51) Int. Cl. G06F 3/12

(52) U.S. Cl. CPC G06F 3/1203; G06F 3/1288; G06F 3/1237

(57) ABSTRACT

To enable an external application to use an image forming apparatus having setting information changed, without depending on user's operation. An image forming apparatus includes a storage device for storing setting information set for the image forming apparatus and a communication device for communicating with an external device. The external device includes a terminal device having an application that operates in collaboration with the image forming apparatus in accordance with collaboration information that matches the setting information. When the setting information is changed, the processor of the image forming apparatus determines whether to transmit a change notice indicating that the setting information has been changed to the terminal device.

Japanese Patent Application No. 2017-028127, 2017-043777, and 2017-057636 filed on Feb. 17, 2017, Mar. 8, 2017, and Mar. 23, 2017, respectively, including description, claims, drawings, and abstract the entire disclosure are incorporated herein by reference in its entirety.

### BACKGROUND

### Technological Field

This disclosure relates to an image forming apparatus, an information processing system, and a method for an image forming apparatus and a terminal device to communicate.

### Description of the Related art

For example, Japanese Laid-Open Patent Publication No. 2014-102604 proposes a technique for a plurality of image forming apparatuses, in which a content set for each image forming apparatus is changed collectively for the image forming apparatuses.

In the technique disclosed in Japanese Laid-Open Patent Publication No. 2015-158783, when a content set in an image forming apparatus is changed, an application of the image forming apparatus or the image forming apparatus is rebooted, thereby making the application available.

### SUMMARY

An external application that uses an image forming apparatus in accordance with setting information of the image forming apparatus becomes unable to connect to the image forming apparatus, if it does not know that the setting information of the image forming apparatus has been changed. The user therefore needs to manually change the setting contents of the external application in accordance with the changed setting information of the image forming apparatus.

Furthermore, when an external application is connected to a plurality of image forming apparatuses, the user need to change the settings for each individual apparatus. For this, each of these image forming apparatuses may give a notice of the changed setting to the external application. This, however, leads to increase of network traffic.

An object of this disclosure according to an aspect is to provide an image forming apparatus and an information processing system to enable an external application to use the image forming apparatus having setting information changed, without depending on user's operation. Another object of this disclosure according to another aspect is to provide a technique for suppressing a traffic increase in a network including an image forming apparatus and a terminal device capable of collaborating with the image forming apparatus.

To achieve at least one of the abovementioned objects, according to an aspect of the present invention, an image forming apparatus reflecting one aspect of the present invention comprises: a processor for controlling the image forming apparatus; a storage device for storing setting information set for the image forming apparatus; and a communication device for communicating with one or more external devices. In the image forming apparatus, the external devices include a terminal device having an application performing collaborative operation with the image forming apparatus in accordance with collaboration information that matches the setting information. When the setting information is changed, the processor determines whether to transmit a change notice indicating that the setting information has been changed to the terminal device.

Preferably, the processor is configured to determine to transmit the change notice when at least part of the collaboration information received from the terminal device does not match the changed setting information.

Preferably, the processor is further configured to determine whether to transmit the change notice, based on history of communication between the terminal device and the image forming apparatus for the collaborative operation by the application.

Preferably, the processor is configured to determine to transmit the change notice when the image forming apparatus communicates with the terminal device for the collaborative operation by the application within a predetermined time since the setting information is changed.

Preferably, the processor is further configured such that the collaboration information of the terminal device is matched with information after change that is the changed setting information, when the change notice is transmitted to the terminal device.

Preferably, the processor is configured to allow the terminal device to perform a matching process of matching the collaboration information with the information after change, when the change notice is transmitted to the terminal device.

Preferably, the processor is further configured to transmit the information after change to the terminal device in order to allow the terminal device to perform the matching process, when the change notice is transmitted to the terminal device.

Preferably, the external devices include an information processing device capable of communicating with the terminal device, and the processor is configured to change the setting information using information for change and transmit the information for change to the application in order to allow the terminal device to perform the matching process.

Preferably, the processor is configured to request the information processing device to transmit the information for change to the terminal device in order to allow the terminal device to perform the matching process.

Preferably, the processor is configured to request the information processing device to transmit the change notice to the terminal device.

According to another aspect of this disclosure, a terminal device that communicates with an image forming apparatus comprises: a processor that controls the terminal device; a storage device for storing collaboration information that matches setting information set in the image forming apparatus; and an application that performs collaborative operation with the image forming apparatus in accordance with the collaboration information. The processor is configured to match the collaboration information with the setting information after change, when receiving a change notice indicating that the setting information has been changed from the image forming apparatus.

According to yet another aspect of this disclosure, an information processing device that communicates with a terminal device comprises a processor that controls the information processing device. The terminal device has an application configured to operate in collaboration with an image forming apparatus in accordance with collaboration information that matches setting information set for the image forming apparatus. The processor is configured to transmit information for change for matching the collaboration information with the setting information after change to the terminal device when the setting information of the image forming apparatus is changed.

An information processing system according to another aspect of this disclosure comprises: an image forming apparatus; and a terminal device that communicates with the image forming apparatus. The image forming apparatus includes a processor for controlling the image forming apparatus and a storage device for storing setting information set for the image forming apparatus. The terminal device includes an application that performs collaborative operation with the image forming apparatus in accordance with collaboration information that matches the setting information. The processor of the image forming apparatus is configured to determine whether to transmit a change notice indicating that the setting information has been changed to the terminal device, when the setting information is changed.

In an aspect, an image forming apparatus included in a plurality of image forming apparatuses configured to have settings changed in accordance with an instruction from an external device is provided. This image forming apparatus comprises: a processor for controlling the image forming apparatus; a storage device for storing setting information set for the image forming apparatus; and a communication interface for communicating with a terminal device and the external device. The processor is configured to operate in accordance with an instruction from the terminal device, acquire identification information of the plurality of image forming apparatuses, determine whether the image forming apparatus is a representative of the plurality of image forming apparatuses, and, when the image forming apparatus is determined to be the representative, transmit identification information of the plurality of image forming apparatuses and change information indicating a changed content in the setting information to the terminal device.

Preferably, the processor is configured to determine whether the image forming apparatus is the representative based on the identification information of each of the plurality of image forming apparatuses.

More preferably, the identification information includes at least one of IP (Internet Protocol) address and MAC (Media Access Control) address.

Preferably, the processor is configured to determine whether the image forming apparatus is the representative, based on history of communication between each of the plurality of image forming apparatuses and the terminal device.

More preferably, the processor is configured to determine whether the image forming apparatus is the representative, based on frequency of communication between each of the plurality of image forming apparatuses and the terminal device.

Preferably, the processor is configured to determine whether the image forming apparatus is the representative, based on the number of times of communication between each of the plurality of image forming apparatuses and the terminal device.

Preferably, the processor is configured to determine whether the image forming apparatus is the representative, based on date and time of communication between each of the plurality of image forming apparatuses and the terminal device.

Preferably, the processor is configured to determine whether the image forming apparatus is the representative, based on quality of communication between each of the plurality of image forming apparatuses and the terminal device.

Preferably, the processor is configured to determine whether the image forming apparatus is the representative, based on device model information of each of the plurality of image forming apparatuses.

Preferably, the processor is configured to determine whether the image forming apparatus is the representative, based on version information of firmware of each of the plurality of image forming apparatuses.

Preferably, the processor is configured to determine whether the image forming apparatus is the representative, based on operating rate of each of the plurality of image forming apparatuses.

Preferably, the processor is configured to determine whether the image forming apparatus is the representative, based on failure rate of each of the plurality of image forming apparatuses.

Preferably, the processor is configured to determine whether the image forming apparatus is the representative, based on information received from another image forming apparatus different from the image forming apparatus, of the plurality of image forming apparatuses. The information received from the other image forming apparatus is information that specifies an image forming apparatus serving as the representative of the plurality of image forming apparatuses.

Preferably, the processor is configured to determine whether the image forming apparatus is the representative, based on information received from the external device. The information received from the external device is information that specifies an image forming apparatus serving as the representative of the plurality of image forming apparatuses.

According to yet another aspect, an information processing system is provided, which comprises: a plurality of image forming apparatuses configured to have settings changed in accordance with an instruction from an external device; and a terminal device configured to communicate with at least one or more image forming apparatuses of the plurality of image forming apparatuses. A predetermined image forming apparatus of the one or more image forming apparatuses selects a representative device from among the plurality of image forming apparatuses. The representative device is configured to acquire identification information of the plurality of image forming apparatuses and transmit the identification information of the plurality of image forming apparatuses and change information indicating a content changed in accordance with an instruction from the external device to the terminal device. The predetermined image forming apparatus is configured to select a new representative device different from the representative device from among the plurality of image forming apparatuses when the representative device fails to transmit the change information and the identification information to the terminal device.

According to yet another aspect of this disclosure, an information processing system is provided, which comprises: a plurality of image forming apparatuses configured to have settings changed in accordance with an instruction from an external device; and a terminal device configured to collaborate with at one or more image forming apparatuses of the plurality of image forming apparatuses. This system is configured to determine whether to transmit a change notice indicating that the settings have been changed to the terminal device when the settings of an image forming apparatus are changed in accordance with an instruction from the external device, specify a sub-group including at least two or more image forming apparatuses in accordance with a predetermined condition, from a main group including image forming apparatuses subjected to a same setting change in accordance with an instruction from the external device, of the plurality of image forming apparatuses, and, when it is determined to transmit the change notice to the terminal device, transmit the change notice or change information indicating a content of the changed settings from the image forming apparatus belonging to the sub-group to the terminal device.

Preferably, the information processing system is configured to specify an image forming apparatus communicating with the terminal device, as an image forming apparatus belonging to the sub-group, among a plurality of image forming apparatuses belonging to the main group.

More preferably, the information processing system is configured to specify an image forming apparatus communicating with the terminal device within a predetermined period, as an image forming apparatus belonging to the sub-group.

Preferably, the information processing system is configured to specify an image forming apparatus belonging to the sub-group, based on information of at least one of installation location and network segment of a plurality of image forming apparatuses belonging to the main group.

Preferably, one image forming apparatus of a plurality of image forming apparatuses belonging to the main group is configured to specify an image forming apparatus belonging to the sub-group. The one image forming apparatus is configured to transmit information of an image forming apparatus belonging to the sub-group to the specified image forming apparatus belonging to the sub-group.

Preferably, the information processing system is configured to select a representative device from among the image forming apparatuses belonging to the sub-group. The representative device acquires identification information of the image forming apparatuses belonging to the sub-group. The information processing system is configured such that the change notice, or the change information and the identification information of the image forming apparatuses belonging to the sub-group are transmitted from the representative device to the terminal device.

More preferably, the information processing system is configured such that the change notice, or the change information and the identification information of the image forming apparatuses belonging to the sub-group are transmitted from the representative device to the terminal device via the external device.

Preferably, the image forming apparatus includes an input device for accepting operation by a user. The information processing system is configured to select the representative device at at least one of: timing when the sub-group is specified; timing when the terminal device accesses any one of a plurality of image forming apparatuses belonging to the sub-group; and timing when the user executes a predetermined process on the input device.

Preferably, the image forming apparatus selected as the representative device is configured to notify each of a plurality of image forming apparatuses belonging to the sub-group that the image forming apparatus is a representative device. Each of a plurality of image forming apparatuses belonging to the sub-group is configured to, in response to being accessed from the terminal device, transmit an access notice indicating access from the terminal device to the representative device.

More preferably, each of a plurality of image forming apparatuses belonging to the sub-group is configured to, in response to being accessed from the terminal device in accordance with the settings before change, transmit the access notice to the representative device.

Preferably, the representative device is configured to, in response to reception of the access notice, transmit the change notice, or the change information and the identification information of the image forming apparatuses belonging to the sub-group to the terminal device.

Preferably, the representative device is configured to transmit, to each of image forming apparatuses belonging to the sub-group, a notice indicating that the change notice, or the change information and the identification information of the image forming apparatuses belonging to the sub-group have been transmitted to the terminal device.

Preferably, the information processing system selects a representative device from among the image forming apparatuses belonging to the sub-group. Each of a plurality of image forming apparatuses belonging to the sub-group is configured to transmit the change notice, or the change information and the identification information of the image forming apparatuses belonging to the sub-group to the terminal device, based on an instruction from the representative device.

Preferably, each of a plurality of image forming apparatuses belonging to the sub-group is configured to transmit the change notice, or the change information and the identification information of the image forming apparatuses belonging to the sub-group to the terminal device, based on an instruction from the external device.

According to yet another aspect of this disclosure, an image forming apparatus configured to be able to collaborate with a terminal device is provided. This image forming apparatus comprises: a communication interface for communicating with an external device and other image forming apparatuses configured to have settings changed in accordance with an instruction from the external device; a storage device for storing setting information set for the image forming apparatus; and a processor that controls communication with the terminal device. The processor is configured to specify a sub-group including at least two or more image forming apparatuses from a main group including image forming apparatuses subjected to a same change to setting information in accordance with an instruction from the external device, from among the other image forming apparatuses, when the setting information is changed in accordance with an instruction from the external device, determine whether to transmit a change notice indicating that the setting information has been changed to the terminal device, and, when it is determined to transmit the change notice to the terminal device, transmit the change notice or change information indicating a content of the changed setting information to the terminal device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating an example of the configuration of an information processing system according to an embodiment.

FIG. 2 is a block diagram illustrating an example of the hardware configuration of a server.

FIG. 3 is a block diagram illustrating an example of the hardware configuration of an MFP.

FIG. 4 is a block diagram illustrating an example of the hardware configuration of a PC.

FIG. 5 is a diagram schematically illustrating a functional configuration of the MFP according to an embodiment.

FIG. 6 is a flowchart of a process according to an embodiment

FIG. 7 is a diagram schematically showing the process in FIG. 6.

FIG. 8 is a diagram schematically showing the process in FIG. 6.

FIG. 9 is a diagram schematically showing the process in FIG. 6.

FIG. 10A is a diagram (1) schematically showing the process in FIG. 6.

FIG. 10B is a diagram (2) schematically showing the process in FIG. 6.

FIG. 10C is a diagram (3) schematically showing the process in FIG. 6.

FIG. 10D is a diagram (4) schematically showing the process in FIG. 6.

FIG. 11 is a flowchart of a process according to an embodiment.

FIG. 12 is a diagram for explaining step S11 in FIG. 11.

FIG. 13 is a flowchart of a process according to an embodiment.

FIG. 14 is a diagram for explaining step S17 and step S19 in the process in FIG. 13.

FIG. 15A is a diagram (1) for explaining the overview of the matching process in step S21 in FIG. 13.

FIG. 15B is a diagram (2) for explaining the overview of the matching process in step S21 in FIG. 13.

FIG. 16 is a flowchart of a process according to an embodiment.

FIG. 17 is a flowchart of a process according to an embodiment.

FIG. 18A is a diagram (1) for explaining an overview of the matching process in step S25 in FIG. 17.

FIG. 18B is a diagram (2) for explaining an overview of the matching process in step S25 in FIG. 17.

FIG. 19 is a flowchart of a process according to an embodiment.

FIG. 20 is a flowchart showing a process in the PC according to an embodiment.

FIG. 21 is a flowchart showing the process in a server according to an embodiment.

FIG. 22 illustrates an example of the data structure of communication history stored in the HDD of the image forming apparatus.

FIG. 23 illustrates an example of the data structure of device information stored in the HDD of the image forming apparatus.

FIG. 24 is a block diagram illustrating an example of the functional configuration of a CPU.

FIG. 25 is a flowchart illustrating a process in a system 1 according to an embodiment.

FIG. 26 is a flowchart illustrating the determination in steps S821 to S823 in FIG. 25.

FIG. 27 is a flowchart illustrating a process in system 1 according to an embodiment.

FIG. 28 is a flowchart illustrating the process in step S1020 in FIG. 27.

FIG. 29 is a flowchart illustrating a process in system 1 according to an embodiment.

FIG. 30 is a flowchart illustrating the process in step S1230 in FIG. 29.

FIG. 31 is a flowchart illustrating a process in the system according to an embodiment.

FIG. 32 is a flowchart illustrating a process in the system according to an embodiment.

FIG. 33 is a flowchart illustrating a process in the system according to an embodiment.

FIG. 34 is a flowchart illustrating the process in step S1020 in FIG. 27 according to an embodiment.

FIG. 35 is a flowchart illustrating the process in step S1020 in FIG. 27 according to an embodiment.

FIG. 36 is a diagram for explaining a process in an information processing system according to a related art.

FIG. 37 is a diagram for explaining a process in an information processing system according to an embodiment.

FIG. 38 is a flowchart illustrating a process of forming a sub-group in the information processing system according to an embodiment.

FIG. 39 is a flowchart illustrating a process of updating collaboration information by the terminal device according to an embodiment.

FIG. 40 is a block diagram for explaining a functional configuration of the information processing system according to an embodiment.

FIG. 41 is a flowchart illustrating a process of updating collaboration information by the terminal device according to a modification.

FIG. 42 is a flowchart illustrating a process of updating collaboration information by the terminal device according to an embodiment.

FIG. 43 is a flowchart illustrating a process of updating collaboration information by the PC according to an embodiment.

FIG. 44 is a block diagram for explaining a functional configuration of the information processing system according to an embodiment.

FIG. 45 is a flowchart illustrating a process of updating collaboration information by the terminal device according to a modification.

FIG. 46 is a flowchart illustrating a process of updating collaboration information by the terminal device according to an embodiment.

FIG. 47 is a flowchart illustrating a process of forming a sub-group in the information processing system according to an embodiment.

FIG. 48 is a block diagram for explaining a functional configuration of the information processing system according to an embodiment.

FIG. 49 is a flowchart illustrating a process of updating collaboration information by the terminal device according to an embodiment.

FIG. 50 is a block diagram for explaining a functional configuration of the information processing system according to an embodiment.

### DETAILED DESCRIPTION OF EMBODIMENTS

Hereinafter, one or more embodiments of the present invention will be described with reference to the drawings. However, the scope of the invention is not limited to the disclosed embodiments.

Embodiments will be described below with reference to the drawings. In the following description, the same parts and components are denoted with the same reference signs. Their names and functions are also the same. A detailed description thereof will not be repeated.

<System Configuration>

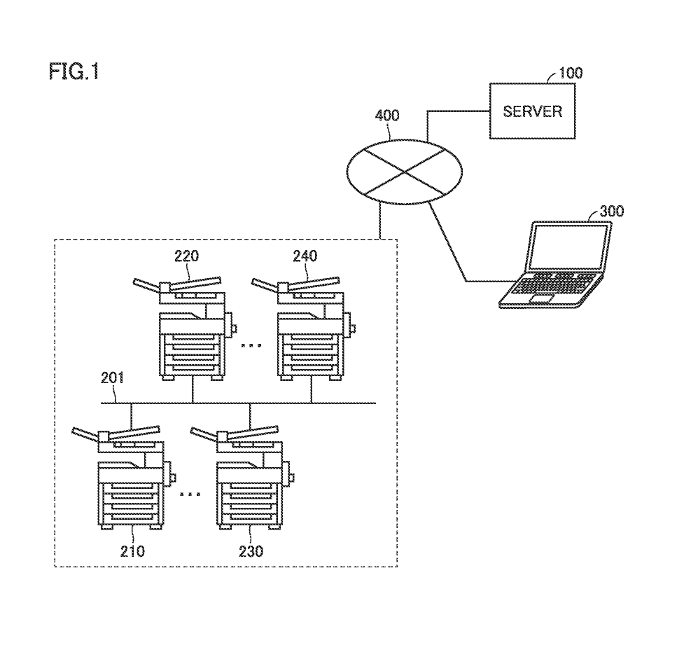

FIG. 1 is a diagram illustrating an example of the configuration of an information processing system (hereinafter simply referred to as system) according to an embodiment. Referring to FIG. 1, the system includes a plurality of image forming apparatuses, a PC (abbreviation of personal computer) 300 as an example of “terminal device”, and a server 100 as an example of “information processing device”, which are connected to each other through a network 400. Network 400 may include a variety of wired or wireless networks.

A plurality of image forming apparatuses include MFPs (Multi-Functional Peripherals) 210, 220, 230, 240. In the embodiment, the MFP is an example of “image forming apparatus”. In the description below, MFPs 210, 220, 230, 240 are collectively referred to as MFP 200. MFPs 200 communicate with each other through a communication circuit 201 such as LAN (Local Area Network).

Although the system includes four MFPs 200 in FIG. 1, five or more MFPs or three or less MFPs may be included. Although PC 300 is a laptop computer in FIG. 1, the embodiment is not limited to this type. <Device Configuration>

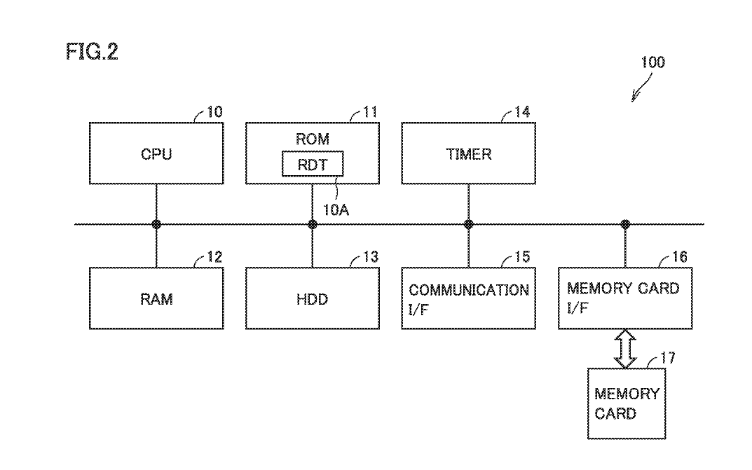

FIG. 2 is a block diagram illustrating an example of the hardware configuration of server 100. Referring to FIG. 2, server 100 includes a CPU (Central Processing Unit) 10 for controlling the entire device. Server 100 also includes a ROM (Read Only Memory) 11 for storing a program to be executed in CPU 10, a RAM (Random Access Memory) 12, and an HDD (Hard Disk Drive) 13. Server 100 further includes a timer 14, a communication I/F 15, and a memory card I/F (Interface) 16. Communication I/F 15 controls communication with other devices through network 400. Memory card I/F 16 reads data (including a program) from an external storage medium such as a memory card 17 removably attached thereto, or writes data (program) into the storage medium.

ROM 11 further includes an RDT (Remote Deployment Tool) 10A. RDT 10A is a program for transmitting data to be used to change setting information 231 of each MFP 200, which will be described later, to each MFP 200.

In HDD 13, information (for example, IP (Internet Protocol) address) about devices such as PC 300 and MFP 200 connected to network 400 and information (for example, passwords for user authentication) about the users of the devices are stored in advance. The hardware configuration of server 100 is not limited to the device configuration in FIG. 2 and may include an output device (for example, printer, display).

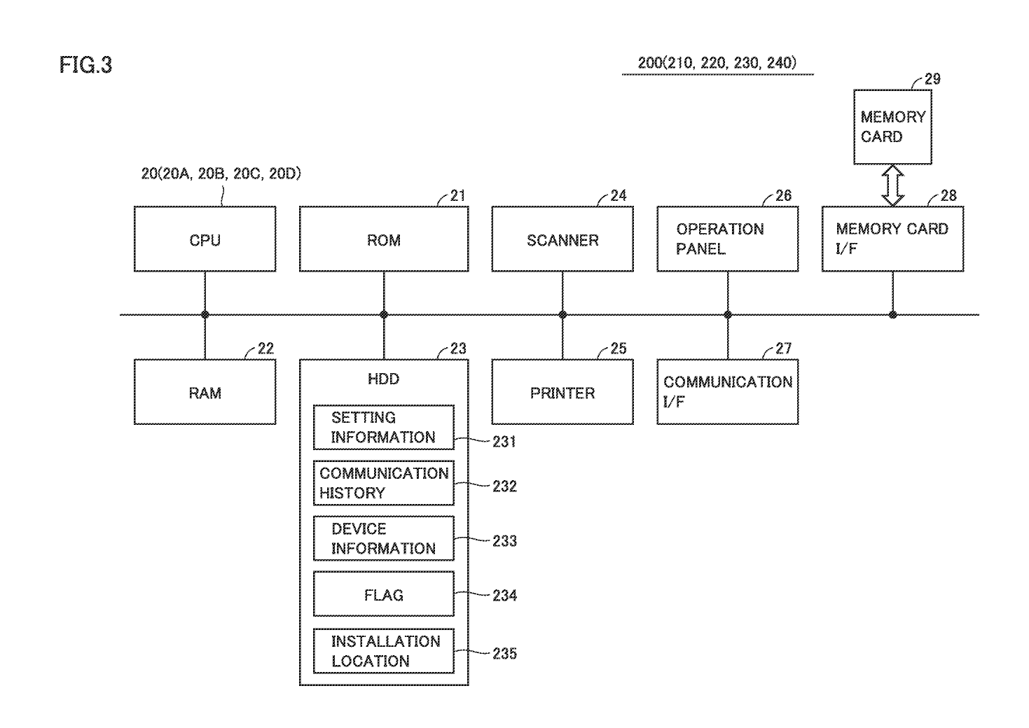

FIG. 3 is a block diagram illustrating an example of the hardware configuration of MFP 200. Referring to FIG. 3, MFP 200 includes a CPU 20, a ROM 21, a RAM 22, an HDD 23, a scanner 24, a printer 25, an operation panel 26, a communication I/F 27, and a memory card I/F 28.

CPU 20 reads and executes a control program stored in ROM 21 to control the operation of MFP 200. RAM 22 functions as a working memory when CPU 20 executes a program.

HDD 23 stores setting information 231, communication history 232, device information 233, flag 234, and installation location information 235. Setting information 231 is information necessary for controlling or using MFP 200. Setting information 231 includes, but not limited to, information for security (for example, password), information about maintenance, information for communication (for example, network address), version information of a control program of MFP 200, and operation schedule (for example, the time for a power-saving operation mode and a normal operation mode). Communication history 232 is history of communication between MFP 200 and other devices (server 100, other MFPs 200, and PC 300) through network 400. Device information 233 is information of MFP 200. Flag 234 represents whether the MFP itself is a representative device, which will be described later. As an example, flag 234 of “1” represents that the MFP itself is the representative device. Flag 234 of “0” represents that the MFP itself is not the representative device. Installation location information 235 is information indicating the location where MFP 200 is installed. In an aspect, the user or the serviceman of MFP 200 can operate operation panel 26 to input or update installation location information 235. The details of communication history 232 and device information 233 will be described later.

Scanner 24 optically reads a document placed on a not-shown platen glass to generate image data. The image data is stored in HDD 23. Printer 25 forms an image on a recording medium based on image data ready by scanner 24 or image data received from PC 300. As an example, operation panel 26 is formed with a liquid display panel and a touch panel laminated together and functions as an input unit to accept operation from a user. Communication I/F 27 controls communication with another MFP 200 through communication circuit 201 and communication with a device (server 100 and PC 300) through network 400. Memory card I/F 28 is configured to read data (including a program) from an external storage medium such as a memory card 29 removably attached thereto or write data into the recording medium.

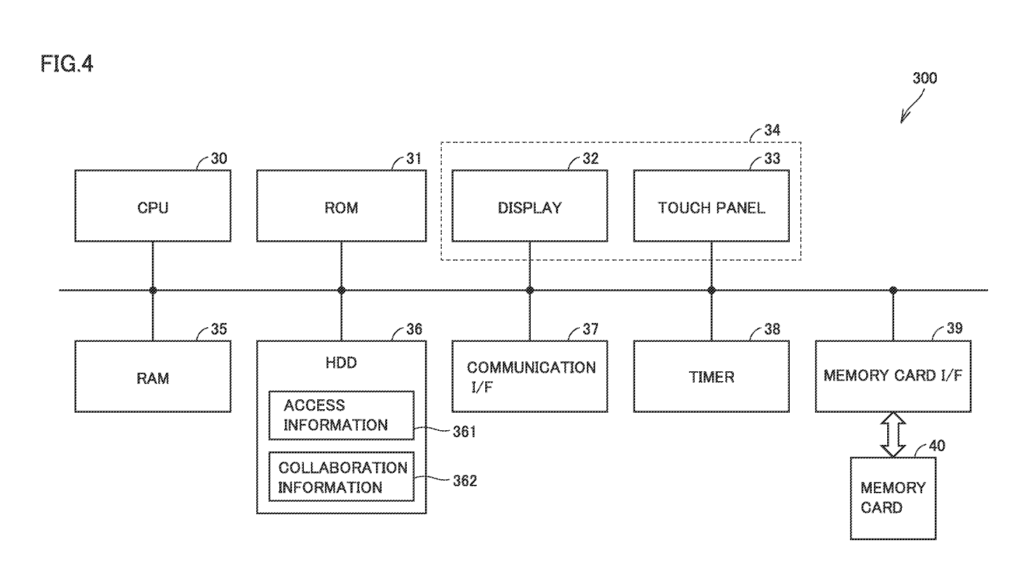

FIG. 4 is a block diagram illustrating an example of the hardware configuration of PC 300. Referring to FIG. 4, PC 300 includes a CPU 30, a ROM 31, an operation panel 34, a RAM 35, an HDD 36, a communication I/F 37, a timer 38, and a memory card I/F 39.

CPU 30 reads and executes a control program stored in ROM 31 to control the operation of PC 300. RAM 35 functions as a working memory when CPU 30 executes a program. Operation panel 34 includes a display 32 and a touch panel 33 to accept operation from a user.

ROM 31 also includes an external application configured to transmit an instruction to MFP 200. CPU 20 can execute the external application to transmit an instruction such as print instruction to MFP 200. In another aspect, PC 300 may transmit an instruction to MFP 200 through a hardware circuit such as ASIC (application specific integrated circuit) or FPGA (field-programmable gate array) configured to set (rewrite) information, in place of an external application.

HDD 36 includes access information 361 and collaboration information 362. Access information 361 includes information for an external application to access MFP 200. Access information 361 may include, for example, authentication information for login to MFP 200 and the IP address of MFP 200. Collaboration information 362 is information necessary for an external application to operate in collaboration with MFP 200. For example, collaboration information 362 includes authentication information (for example, password) of MFP 200, information about maintenance of MFP 200, information for accessing MFP 200 (for example, network address), version information of a control program of MFP 200, and operation schedule of MFP 200. Collaboration information 362 is stored for each MFP 200 that PC 300 collaborates with.

Communication I/F 37 controls communication with other devices (server 100 and MFP 200) through network 400. Memory card I/F 39 is configured to read data (including a program) from an external storage medium such as a memory card 40 removably attached thereto or write data into the recording medium.

<Description of Terms>

The terms used in the embodiments will be described.

“MFP setting information” is an example of “setting information”. “MFP setting information” is information that can be changed and set for MFP 200 to control or use MFP 200. “MFP setting information” is stored in a rewritable storage area of MFP 200. “MFP setting information” includes, but not limited to, authentication information (for example password) for authenticating a user, information for communicating with an external device (for example, IP address), version information of a control program of MFP 200, and operation schedule (for example, the time for a power-saving operation mode and a normal operation mode).

“Old MFP setting information” indicates MFP setting information before a change is made. “New MFP setting information” indicates MFP setting information after a change is made and is an example of “information after change”.

“External application” is an application that collaborates with MFP 200. The external application is software (program) executed by a processor, by way of illustration, in an embodiment but not limited to software and may be a hardware circuit such as ASIC (application specific integrated circuit) or FPGA (field-programmable gate array).

The collaborative operation of “external application” includes operation for acquiring information from MFP 200 while communicating with MFP 200. The information acquired includes, for example, information about operation of MFP 200 (for example, count values such as the number of copies and the number of sheets left, information of users who have used the MFP).

“App setting information” is an example of “collaboration information” necessary for the external application to operate in collaboration with MFP 200. When “collaboration information” matches the MFP setting information of MFP 200, the external application can operate in collaboration with MFP 200, but when it does not match, the external application cannot operate in collaboration.

“Matching process” refers to a process for changing the app setting information so as to match part or the whole of new MFP setting information. The matching process may include a process of changing the app setting information so as to completely match part or the whole of new MFP setting information.

“Change notice” is a notice indicating that “MFP setting information” of MFP 200 has been changed using “information for change”.

“RDT (Remote Deployment Tool)” is a program executed by server 100 to change the MFP setting information.

<Process Overview>

In an embodiment, when the MFP setting information is changed, MFP 200 determines whether it is necessary to transmit a change notice to PC 300 having the external application. When receiving a change notice from MFP 200 directly or via server 100, PC 300 performs a matching process for matching the app setting information with the MFP setting information after change, using the information for change. The external application can operate in collaboration with MFP 200 after the MFP setting information is changed, in accordance with the app setting information acquired through the matching process.

In an embodiment, the MFP setting information includes a plurality of items including the password for authentication and the time for a power-saving operation mode. When a predetermined item in the MFP setting information is changed, MFP 200 transmits a change notice. The predetermined item is an item necessary for the external application to operate in collaboration with MFP 200, for example, password. The predetermined item is not limited to password.

<Functional Configuration of MFP 200>

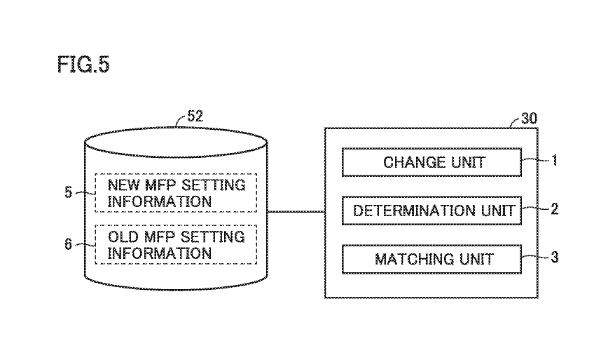

FIG. 5 is a diagram schematically illustrating a functional configuration of MFP 200 according to an embodiment. In FIG. 5, the functions of MFP 200 are associated with new MFP setting information 5 and old MFP setting information 6 stored in a nonvolatile storage area of RAM 22.

Referring to FIG. 5, MFP 200 includes a change unit 1 configured to change old MFP setting information 6 in RAM 22 to new MFP setting information 5 using information for change, a determination unit 2 configured to determine whether to transmit a change notice indicating that a change has been made to PC 300 when a change is made by change unit 1, and a matching unit 3. New MFP setting information 5 is an example of “information after change”. When a change notice is transmitted to PC 300, matching unit 3 performs a process for matching app setting information 30B (described later) of PC 300 with new MFP setting information 5.

In an embodiment, change unit 1, determination unit 2, and matching unit 3 are implemented by a program executed by CPU 30 but may be implemented by a combination of a program and a circuit, rather than by a program.

[Updating of Setting Information]

(Process 1)

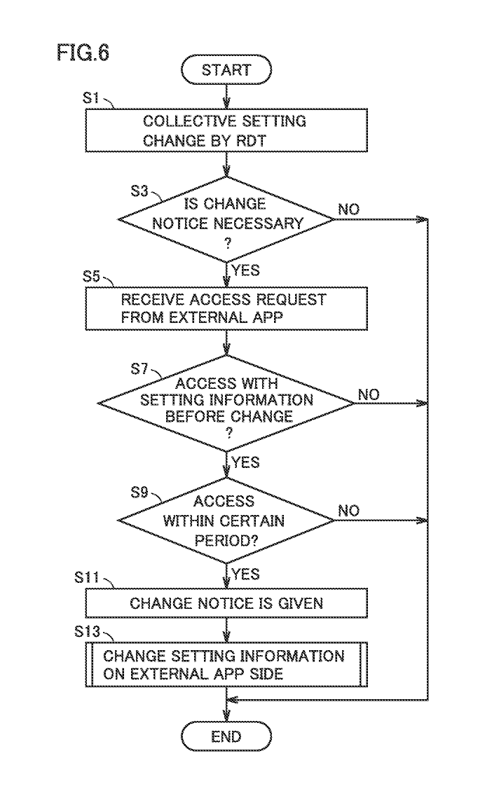

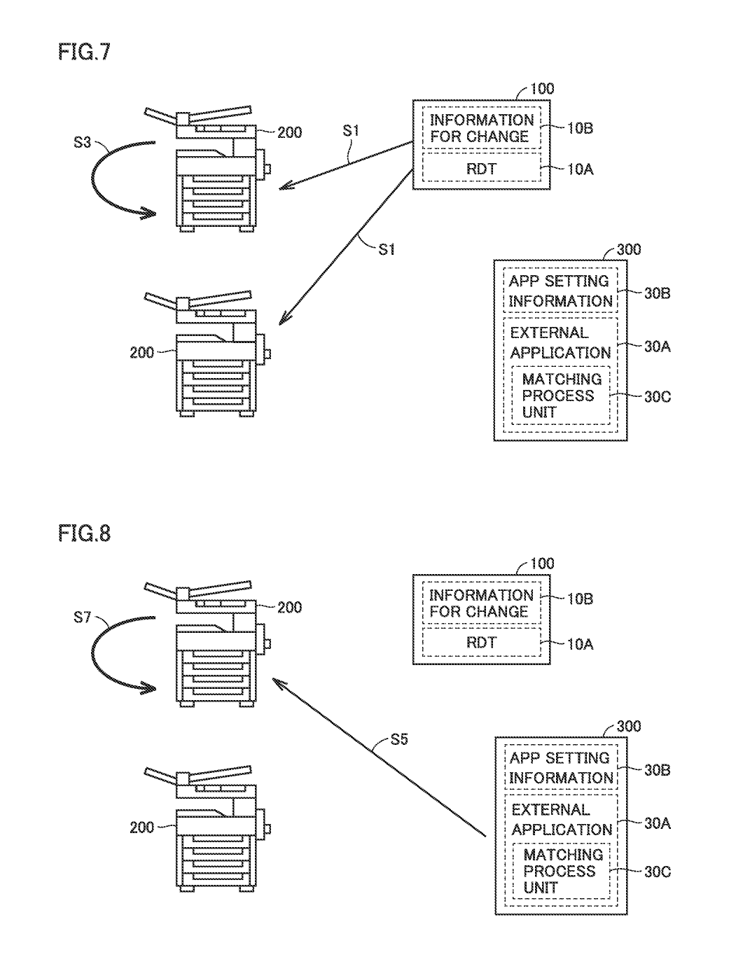

FIG. 6 is a flowchart of a process according to an embodiment. FIG. 7 to FIG. 10D are diagrams for explaining the step in the process in FIG. 6. For simplicity of explanation, FIG. 7 to FIG. 10D show a case where the MFP setting information of two MFPs 200 is changed.

FIG. 7 to FIG. 9 schematically show the processing in steps S1 to S11 in FIG. 6. Referring to FIG. 7 to FIG. 9, RDT 10A and information for change 10B are stored, for example, in a storage of server 100. CPU 101 executes RDT 10A. In PC 300, the program of external application 30A, app setting information 30B, and the program of matching process unit 30C are stored in a storage. CPU 30 executes the program of external application 30A for collaborative operation and executes the program of matching process unit 30C. The program of matching process unit 30C is executed to implement the matching process. Matching process unit 30C is shown as part of the program of external application 30A but may be generated as a separate program.

The MFP setting information of each MFP 200 in FIG. 1 is collectively changed using information for change 10B from server 100 (step S1, see FIG. 7). That is, change unit 1 of each MFP 200 changes old MFP setting information 6 using information for change 10B received from RDT 10A of server 100 to generate new MFP setting information 5. Information for change 10B includes the identifier of an item and a value after change of the item.

When the MFP setting information is changed, determination unit 2 determines whether it is necessary to transmit a change notice to PC 300 (step S3, see FIG. 7). If determination unit 2 determines that it is not necessary to transmit a change notice (NO in step S3), the process ends. If it is determined that it is necessary to transmit a change notice (YES in step S3), the process proceeds to step S5. For example, determination unit 2 compares the identifier of a predetermined item described in a definition file stored in HDD 23 with the identifier of the changed item in the MFP setting information. Based on the result of comparison, if the identifiers of the items match, determination unit 2 determines that transmission of a change notice is necessary. If they do not match, determination unit 2 determines that transmission of a change notice is unnecessary.

CPU 50 receives an access request from external application 30A (step S5, see FIG. 8). The access request is a request for accessing (read/write) a count value stored in the storage of MFP 200. The access request includes a password in app setting information 30B.

CPU 50 determines whether the access request from external application 30A includes the setting information before change, that is, the password before change (step S7, see FIG. 8). For example, CPU 50 compares the password in new MFP setting information 5 with the password in the access request and determines whether they match (step S7). If CPU 50 determines that the passwords match (YES in step S7), the process ends.

On the other hand, if CPU 50 determines that the passwords do not match (NO in step S7), the process proceeds to step S11. That is, when the password in the access request does not match the password in new MFP setting information 5, the process proceeds to step S9 to perform a matching process.

Determination unit 2 determines, from history of communication, whether an access request from external application 30A has been received in a certain period (for example, a predetermined period such as the past one month) since the MFP setting information is changed (step S9). This certain period is variable, for example, may be variable depending on the kind of external application 30A.

The history of communication is stored in the storage by CPU 50 of MFP 200 so that information about communication is accumulated every time MFP 200 communicates with a variety of applications in the external terminal device. The history of communication includes, for each application (or terminal device), the IP address, which is an example of its identifier, and the communication time associated with each other.

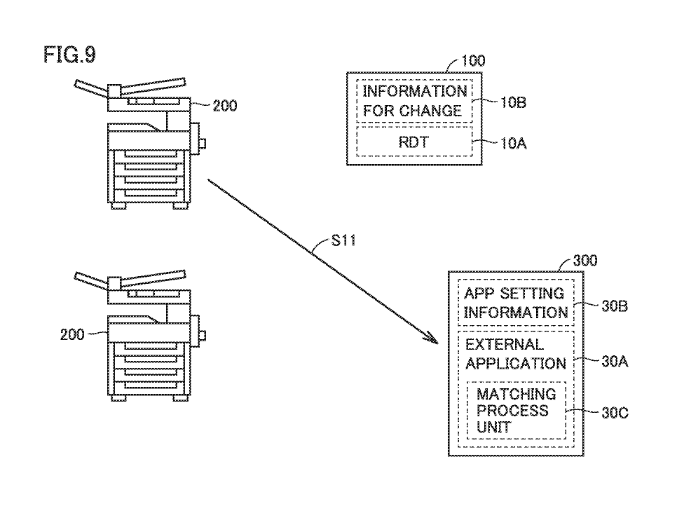

If determination unit 2 determines that an access request has been received outside the certain period (NO in step S9), the process ends. If it is determined that an access request has been received within a certain period (YES in step S9), a change notice is transmitted to PC 300 (step S11, see FIG. 9). Matching unit 3 then allows PC 300 to perform a matching process (step S13). The process in FIG. 6 thereafter ends.

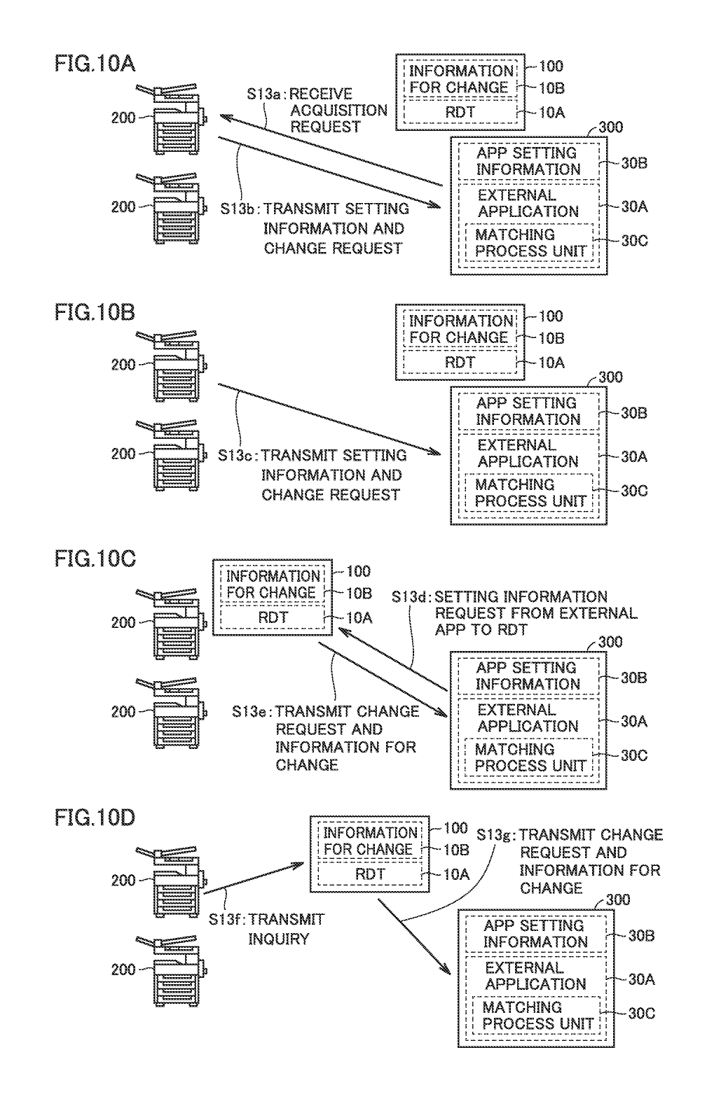

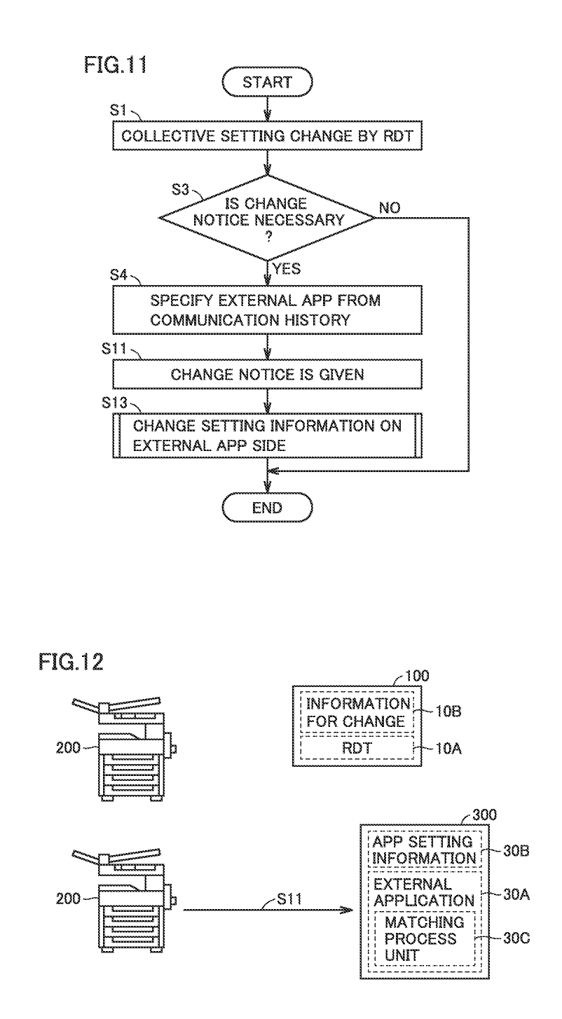

The processing in step S13 will be described with reference to FIG. 10A to FIG. 10D. In step S13, any one of four patterns in FIG. 10A to FIG. 10D is performed. For example, a pattern to be performed is switched according to the kind of external application 30A.

In FIG. 10A, matching process unit 30C of PC 300, receiving a change notice, transmits a request to acquire setting information to MFP 200. Matching unit 3 of MFP 200 receives the request to acquire (step S13a). In response to the request to acquire, matching unit 3 transmits new MFP setting information 5 and a request to change (step S13b). Matching process unit 30C of PC 300 performs a matching process using new MFP setting information 5, in accordance with the request to change from MFP 200. App setting information 30B is thus changed to match new MFP setting information 5.

In FIG. 10B, matching unit 3 of MFP 200 transmits new MFP setting information 5 and a request to change to PC 300 (step S13c). Matching process unit 30C of PC 300 performs a matching process using new MFP setting information 5 in accordance with the request to change from MFP 200. App setting information 30B is thus changed to match new MFP setting information 5.

In FIG. 10C, when receiving a change notice, matching process unit 30C of PC 300 transmits a request to acquire setting information to server 100 (step S13d). When receiving the request to acquire, RDT 10A of server 100 transmits a request to change and information for change 10B to PC 300 (step S13e). Matching process unit 30C of PC 300 performs a matching process using information for change 10B in accordance with the request to change from server 100. App setting information 30B is thus changed to match new MFP setting information 5.

In FIG. 10D, matching unit 3 of MFP 200 transmits a transmission request to server 100 (step S13f). This transmission request indicates a content to request server 100 to transmit new MFP setting information 5 (or information for change 10B) to PC 300.

In response to the transmission request from MFP 200, server 100 transmits a request to change and information for change 10B to the designated PC 300 (step S13g). Matching process unit 30C of PC 300 performs a matching process using information for change 10B in accordance with the request to change from server 100. App setting information 30B is thus changed to match new MFP setting information 5. CPU 30 of PC 300 changes (updates) app setting information 30B to match new MFP setting information 5 using information for change 10B, in accordance with the request to change from server 100.

Here, in steps S13e and 13g, although server 100 transmits information for change 10B to PC 300 for a matching process, the embodiment is not limited to information for change 10B. For example, server 100 may generate and transmit new MFP setting information 5 to PC 300. Specifically, CPU 10 of server 100 generates new MFP setting information 5 from information for change 10B transmitted to MFP 200 or may receive new MFP setting information 5 from MFP 200 to acquire new MFP setting information 5 and transmit the acquired new MFP setting information 5 to PC 300.

In an embodiment, when the MFP setting information is changed, the matching process in any one of FIG. 10A to FIG. 10D is executed so that app setting information 30B also can be changed to match the MFP setting information after change.

(Process 2)

In an embodiment, the comparison of the password in the access request is eliminated (step S7 in FIG. 6), and external application 30A to be subjected to a matching process is determined from the history of communication (log).

FIG. 11 is a flowchart of a process according to an embodiment. FIG. 12 is a diagram for explaining step S11 in FIG. 11. The processing in steps S1, S3 and S11 in FIG. 11 is the same as the processing described in FIG. 6 and a detailed description thereof will not be repeated.

Referring to FIG. 11, change unit 1 of MFP 200 changes old MFP setting information 6 to new MFP setting information 5, based on information for change 10B received from server 100 (step S1). Determination unit 2 determines whether transmission of a change notice is necessary (step S3). If determination unit 2 determines that transmission of a change notice is not necessary (NO in step S3), the process ends. If it is determined that transmission of a change notice is necessary (YES in step S3), the process proceeds to step S4.

Determination unit 2 specifies (determines) information of external application 30A that has communicated in the certain period, from the communication history (step S4). The criterion for determining external application 30A is not limited to the access within the certain period. For example, the frequency (number of times) of access, the length of communication time, and the like may be the criteria.

CPU 50 transmits a change notice to PC 300 having external application 30A specified in step S4 (step S11, see FIG. 12). Matching unit 3 then allows PC 300 to perform the matching process described above (step S13). The process in FIG. 11 then ends. In the matching process in step S13, any one of the processing in FIG. 10A to FIG. 10D described above is performed and a description thereof will not be repeated here.

(Process 3)

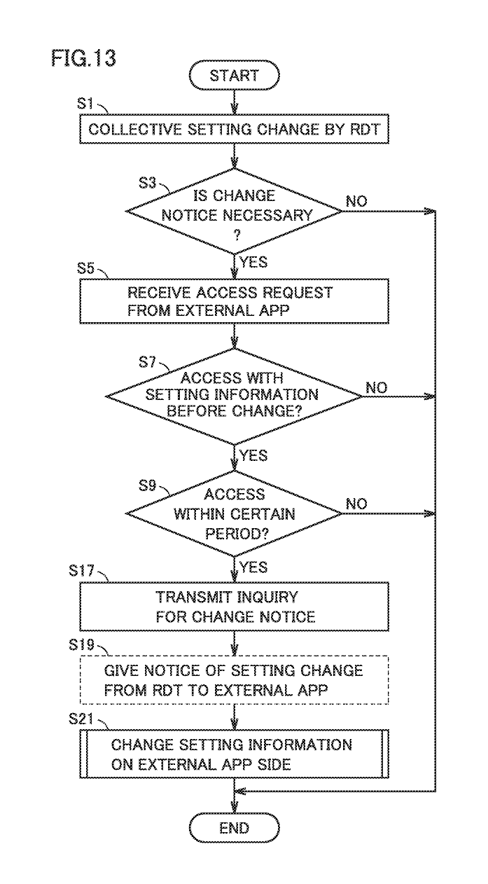

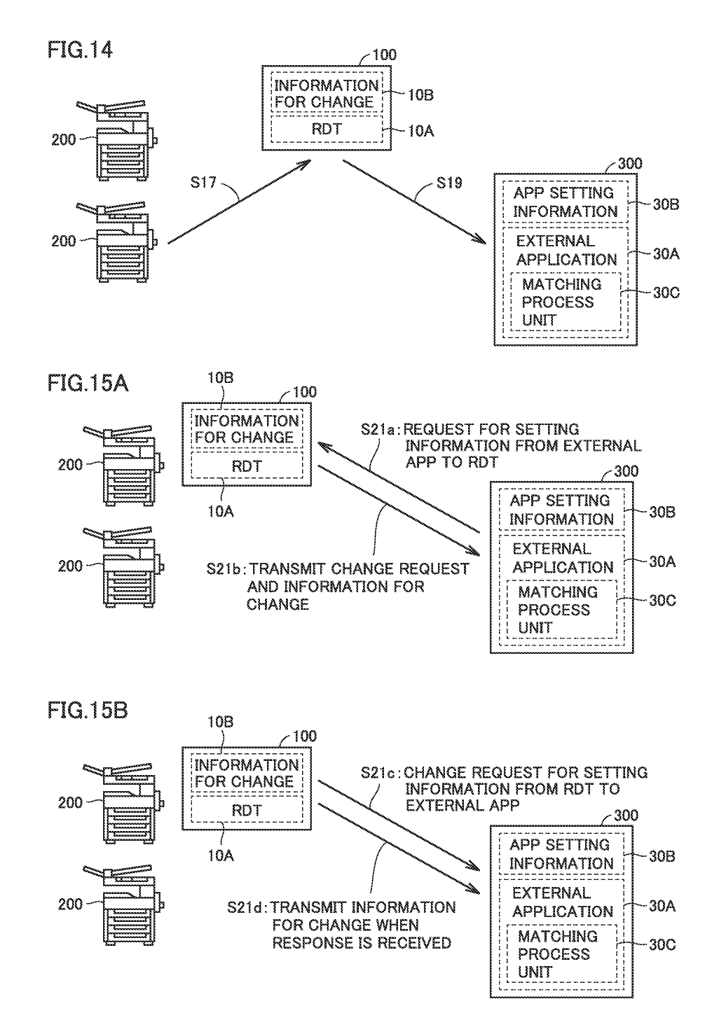

In an embodiment, matching process unit 30C of PC 300 performs a matching process using information for change 10B received from RDT 10A. FIG. 13 is a flowchart of a process according to an embodiment. FIG. 14 is a diagram for explaining step S17 and step S19 in the process in FIG. 13. FIG. 15A and FIG. 15B are diagrams for explaining the overview of the matching process in step S21 in FIG. 13. The processing in steps S1, S3, S5, S7 and S9 in FIG. 13 is similar to the processing described in FIG. 6 and a detailed description thereof will not be repeated.

Referring to FIG. 13, change unit 1 of MFP 200 changes old MFP setting information 6 to new MFP setting information 5, based on information for change 10B from RDT 10A (step S1). If determination unit 2 determines that transmission of a change notice is necessary (YES in step S3), CPU 50 receives an access request from external application 30A (step S5).

If determination unit 2 determines that the access request includes a password before the setting change (YES in step S7), when it is determined that the access request has been received within a certain period since the MFP setting information is changed (YES in step S9), the process proceeds to step S17.

In step S17, CPU 50 of MFP 200 transmits an inquiry for a matching process to RDT 10A of server 100 (step S17, FIG. 14). The inquiry indicates a content to ask (request) RDT 10A of server 100 to perform the processing between MFP 200 and PC 300.

RDT 10A transmits a change notice to external application 30A in accordance with the inquiry from MFP 200 (step S19, FIG. 14). A matching process by matching process unit 30C is performed (step S21). The process in FIG. 13 then ends.

Referring to FIG. 15A and FIG. 15B, the matching process in step S21 will be described. In step S21, the process in one of FIG. 15A and FIG. 15B is performed. For example, the process to be performed is determined according to the kind of external application 30A.

In FIG. 15A, external application 30A receives a change notice and then transmits a request to acquire to RDT 10A of server 100 (step S21a). When RDT 10A receives the request to acquire from external application 30A in a case where it has transmitted a change notice in accordance with the notice inquiry, RDT 10A transmits a request to change and information for change 10B to external application 30A (step S21b). Matching process unit 30C performs a matching process using information for change 10B from RDT 10A, in accordance with the request to change from RDT 10A.

In FIG. 15B, if receiving the inquiry from MFP 200, RDT 10A transmits a request to change to PC 300 (step S21c). When receiving a response to the request to change from PC 300, RDT 10A transmits information for change 10B to PC 300 (step S21d). Matching process unit 30C performs a matching process using information for change 10B from RDT 10A, in accordance with the request to change from RDT 10A.

In an embodiment, if determination unit 2 of MFP 200 determines that transmission of a change notice is necessary, the subsequent matching process is performed between RDT 10A of server 100 and PC 300, which can reduce the burden on MFP 200.

(Process 4)

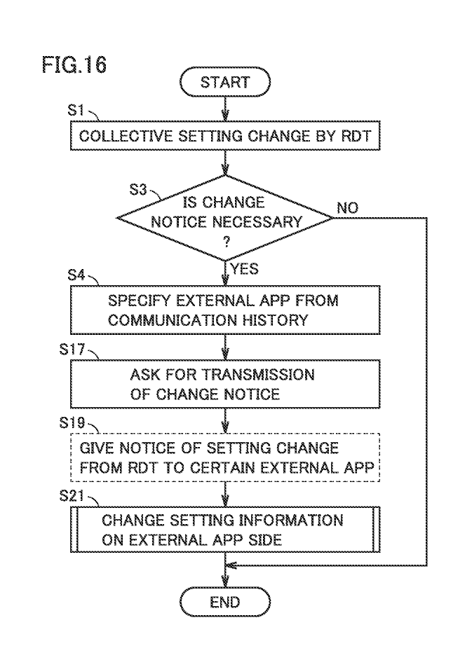

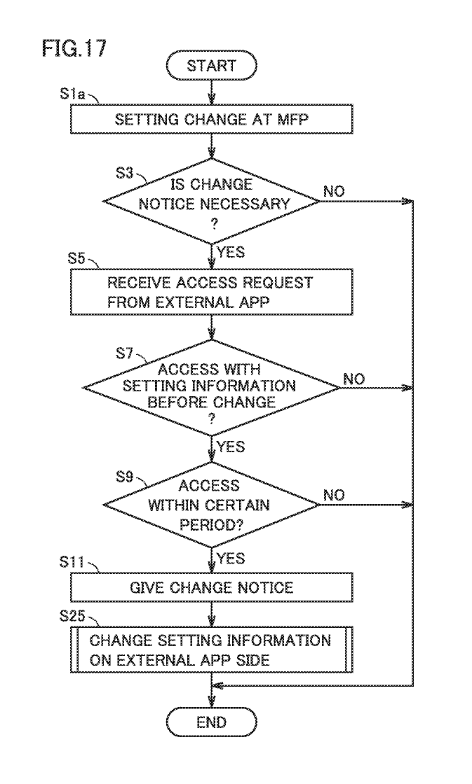

FIG. 16 is a flowchart of a process according to an embodiment. The process in FIG. 16 is similar to the process in FIG. 13 except that the processing in steps S5, S7 and S9 in FIG. 13 is changed to step S4 in FIG. 11, and a detailed description thereof will not be repeated.

Referring to FIG. 16, change unit 1 of MFP 200 changes old MFP setting information 6 to new MFP setting information 5, based on information for change 10B from RDT 10A (step S1). If determination unit 2 determines that transmission of a change notice is necessary (YES in step S3), external application 30A to which a change notice is to be transmitted is specified (determined) based on the communication history (step S4).

Subsequently, when CPU 50 of MFP 200 transmits the inquiry to RDT 10A (step S17), RDT 10A transmits a change notice to PC 300 having the designated external application 30A, in accordance with the inquiry (step S19), and then a matching process is performed by matching process unit 30C of PC 300 (step S21). The process in FIG. 16 then ends.

(Process 5)

In the example above, the MFP setting information of each MFP 200 is changed using information for change 10B from RDT 10A. Alternatively, in an embodiment, the MFP setting information is changed without using RDT 10A.

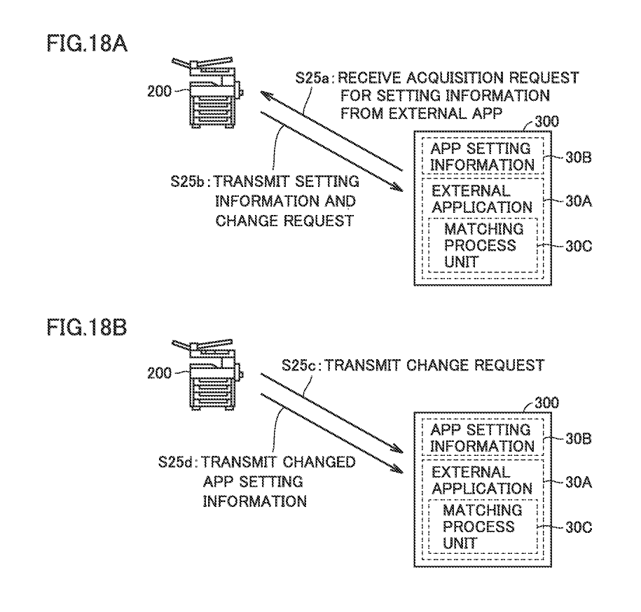

FIG. 17 is a flowchart of a process according to an embodiment. FIG. 18A and FIG. 18B are diagrams for explaining an overview of the matching process in step S25 in FIG. 17. Referring to FIG. 17, change unit 1 of MFP 200 extracts information for change from the content of user's operation accepted through operation panel 26 and changes the MFP setting information based on the extracted information for change (step S1a). Old MFP setting information 6 is thus changed to new MFP setting information 5. Subsequently, the processing in steps S3 to S11 is performed for transmitting a change notice to external application 30A. The processing in steps S3 to S11 in FIG. 17 is similar to the corresponding processing shown in FIG. 6 and details thereof will not be repeated.

When a change notice is transmitted to PC 300, a matching process (step S25) by matching process unit 30C is performed. The matching process in step S25 will be described with reference to FIG. 18A and FIG. 18B. In step S25, the process in one of FIG. 18A and FIG. 18B is performed. For example, the process to be performed is determined according to the kind of external application 30A.

In FIG. 18A, external application 30A receives a change notice and then transmits a request to acquire setting information to MFP 200, and CPU 50 of MFP 200 receives the request to acquire from external application 30A (step S25a). In response to the request to acquire, matching unit 3 of MFP 200 transmits a request to change and new MFP setting information 5 (step S25b). External application 30A performs a matching process using new MFP setting information 5, in accordance with the request to change from MFP 200.

In FIG. 18B, matching unit 3 of MFP 200 transmits a request to change app setting information 30B to external application 30A (step S25c). Matching unit 3, receiving a response from external application 30A, transmits new MFP setting information 5 to PC 300 (step S25d). Matching process unit 30C performs a matching process using new MFP setting information 5 in accordance with the request to change from MFP 200.

(Process 6)

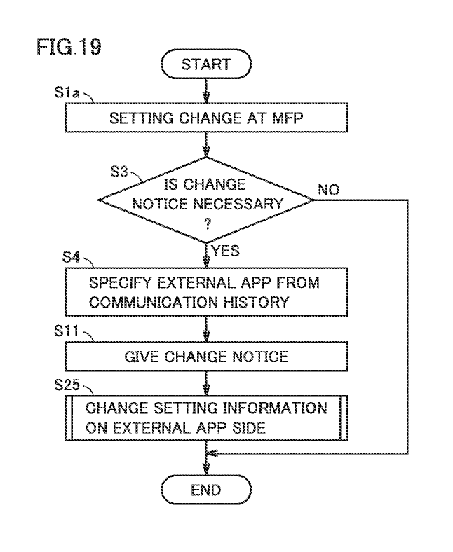

In an embodiment, each MFP 200 changes its own MFP setting information. FIG. 19 is a flowchart of a process according to an embodiment.

Referring to FIG. 19, change unit 1 of MFP 200 changes the MFP setting information based on the information for change accepted from the user (step S1a). Subsequently, the processing in steps S3, S4 and S11 is performed for transmitting a change notice to external application 30A. The processing in steps S3 to S11 in FIG. 19 is similar to the processing in steps S3 to S11 in FIG. 11 and details thereof will not be repeated.

When a change notice is transmitted to PC 300, matching process unit 30C performs a matching process (step S25). The matching process in step S25 is similar to the process shown in FIG. 18A or FIG. 18B and a description thereof will not be repeated.

(Process 7)

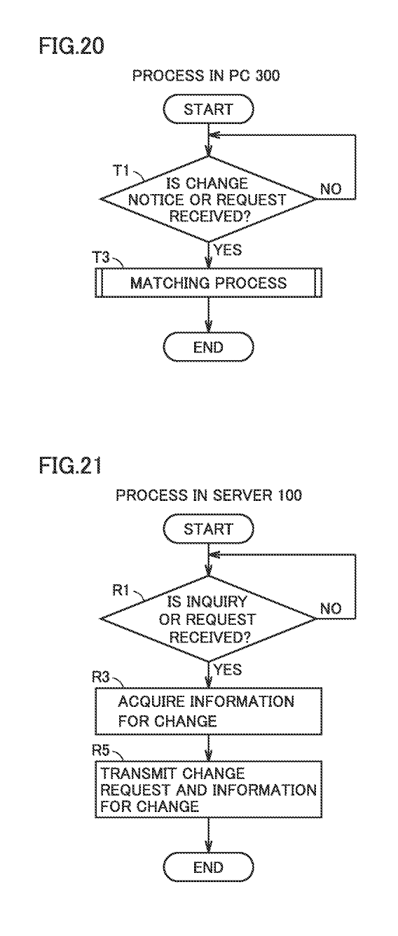

The matching process in PC 300 will now be illustrated. FIG. 20 is a flowchart showing a process in PC 300 according to an embodiment. Referring to FIG. 20, matching process unit 30C of PC 300 determines whether to receive a change notice or a request (step T1). The processing in step T1 is repeated until a change notice or a request is received. When a change notice or a request is received (YES in step T1), matching process unit 30C performs a matching process using information for change 10B (or new MFP setting information 5) (step T3).

(Process 8)

The process in server 100 will now be described. FIG. 21 is a flowchart showing a process in server 100 according to an embodiment. Referring to FIG. 21, CPU 10 (RDT 10A) determines whether to receive an inquiry from MFP 200 or a request from PC 300 (step R1). The processing in step R1 is repeated until an inquiry or a request is received. When an inquiry or a request is received (YES in step R1), CPU 10 acquires information for change 10B (or new MFP setting information 5) (step R3). Specifically, CPU 10 reads information for change 10B from the storage, or generates new MFP setting information 5, or receives new MFP setting information 5 from MFP 200 to acquire the information.

CPU 10 transmits the acquired information for change 10B (or new MFP setting information 5) together with a request to change to PC 300 for a matching process (step R5).

[Traffic Control 1]

(Communication History)

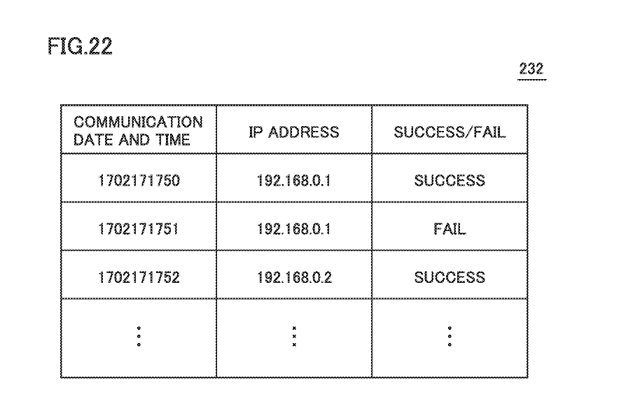

FIG. 22 illustrates an example of the data structure of communication history 232 stored in HDD 23 of MFP 200. Communication history 232 holds communication date and time, IP address, and success/failure information associated with each other. The IP address functions as identification information on network 400 of another device that MFP 200 communicates with (server 100, other MFPs 200, PC 300). The success/failure information represents whether communication with another device is successful. For example, CPU 20 may determine that communication is successful when an ACK (ACKnowledgement) signal is received from another device, and may determine that communication is failed when a NACK (Negative ACKnowledgement) signal is received. CPU 20 stores the communication date and time, the IP address of another device, and the success/failure information into communication history 232 every time communication with another device is performed.

(Device Information)

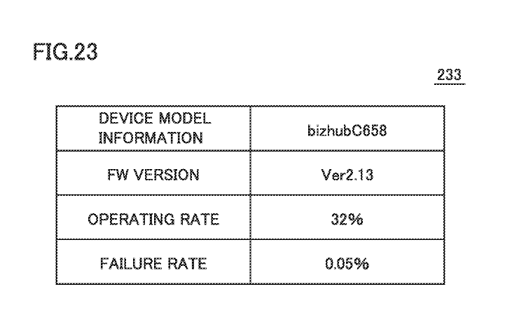

FIG. 23 illustrates an example of the data structure of device information 233 stored in HDD 23 of MFP 200. Device information 233 holds device model information, version information of firmware (FW), operating rate, and failure rate.

The device model information represents the product name of MFP 200, as an example The device model information may further include information such as the release date of the product. The version information of FW represents the version of FW built in MFP 200. The operating rate represents the proportion of the time in which MFP 200 is operating relative to a time interval (for example, 24 hours), as an example When MFP 200 is configured to be switchable between a power-saving mode and a normal mode, the operating rate may represent the proportion of the time during which MFP 200 is set to the normal mode relative to a time interval. The power-saving mode is, for example, a mode in which electricity is supplied only to CPU 20, operation panel 26, and communication I/F 27. The failure rate is the proportion of the time during which some error occurs in MFP 200 relative to the time in the normal mode, as an example.

(Functional Configuration of Control Device of Image Forming Apparatus)

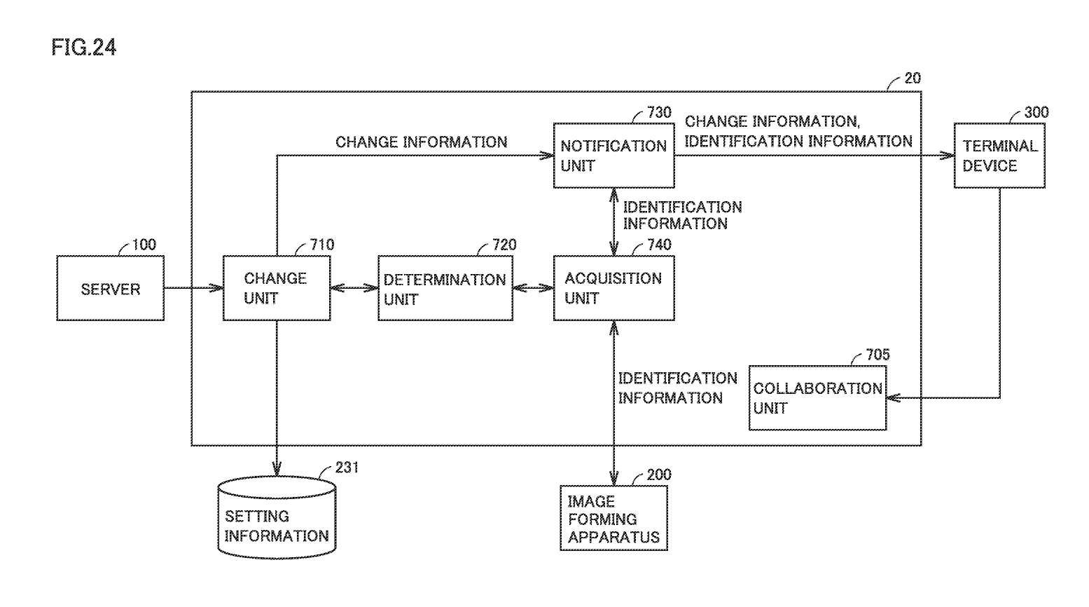

FIG. 24 is a block diagram illustrating an example of the functional configuration of CPU 20. CPU 20 reads and executes a control program stored in ROM 21 to function as a collaboration unit 705, a change unit 710, a determination unit 720, a notification unit 730, and an acquisition unit 740.

Collaboration unit 705 accepts an operation instruction from PC 300 and operates scanner 24, printer 25, and the like based on the operation instruction. In doing so, PC 300 refers to access information 361 stored in HDD 36 to access MFP 200.

Change unit 710 changes setting information 231 in accordance with a change instruction from server 100. Change unit 710 outputs information indicating that setting information 231 has been changed to determination unit 720.

Determination unit 720 determines whether MFP 200 is a representative (which hereinafter may be referred to as “representative device”) of a plurality of MFPs 200. For example, determination unit 720 of MFP 210 determines whether MFP 210 is a representative device in an image forming apparatus group including MFPs 210, 220, 230. Determination unit 720 outputs the determination result to change unit 710 and acquisition unit 740. Change unit 710 outputs information indicating the changed content (which hereinafter may be referred to as “change information”) in setting information 231 to notification unit 730, in accordance with input of the determination result that MFP 200 is a representative device from determination unit 720.

Acquisition unit 740 acquires the identification information (for example, IP address) of another MFP 200 in accordance with the determination result that MFP 200 is a representative device from determination unit 720. Acquisition unit 740 outputs the acquired identification information to notification unit 730.

Notification unit 730 transmits the change information and the identification information of MFP 200 (which may include the identification information of the MFP itself) to PC 300 through communication I/F 27. PC 300 updates access information 361 with the received change information and identification information of MFP 200.

(Process 1)

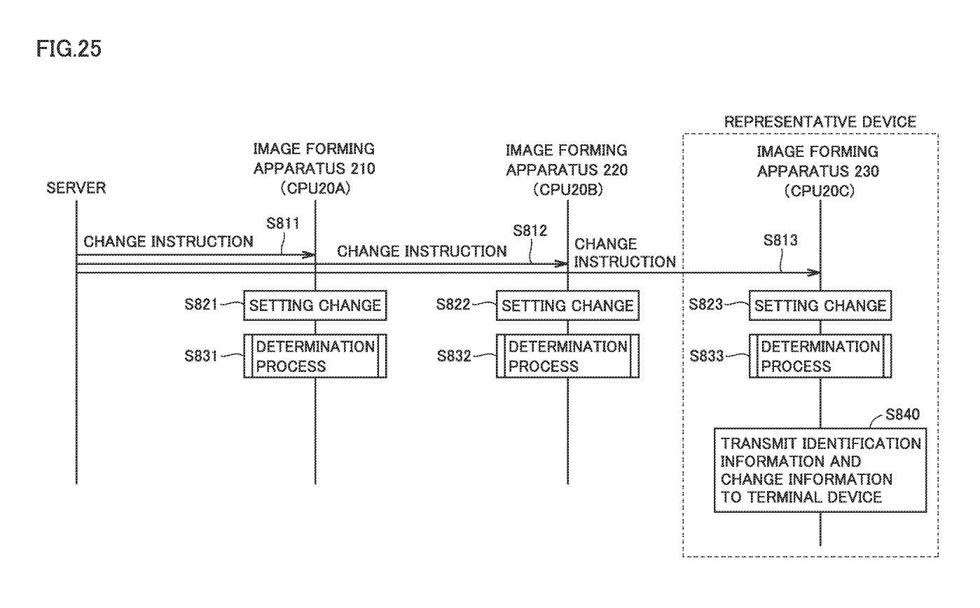

FIG. 25 is a flowchart illustrating a process of a system 1 according to an embodiment. The processes shown in FIG. 25 and FIG. 26 to FIG. 34 described later may be implemented by CPU 10 of server 100 executing a control program stored in ROM 11 and by CPU 20 of MFP 200 executing a control program stored in ROM 21. In another aspect, part or the whole of the process may be implemented by a circuit element or other hardware.

In the following, CPU 20 of MFP 210 is defined as “CPU 20A”, CPU 20 of MFP 220 is defined as “CPU 20B”, CPU 20 of MFP 230 is defined as “CPU 20C”, and CPU 20 of MFP 240 is defined as “CPU 20D”.

In steps S811 to S813, server 100 transmits a change instruction to each MFP 200 (210, 220, 230) in accordance with RDT 10A. In steps S821 to S823, CPU 20 of each MFP 200, serving as a change unit 710, updates setting information 231 in accordance with the change instruction.

In steps S831 to S833, each CPU 20, serving as determination unit 720, determines whether the MFP itself is a representative device. In the example in FIG. 25, MFP 230 determines that MFP 230 itself is a representative device.

In step S840, MFP 230 transmits the change information and the identification information of each MFP 200 to PC 300, in accordance with the determination that MFP 230 itself is a representative device.

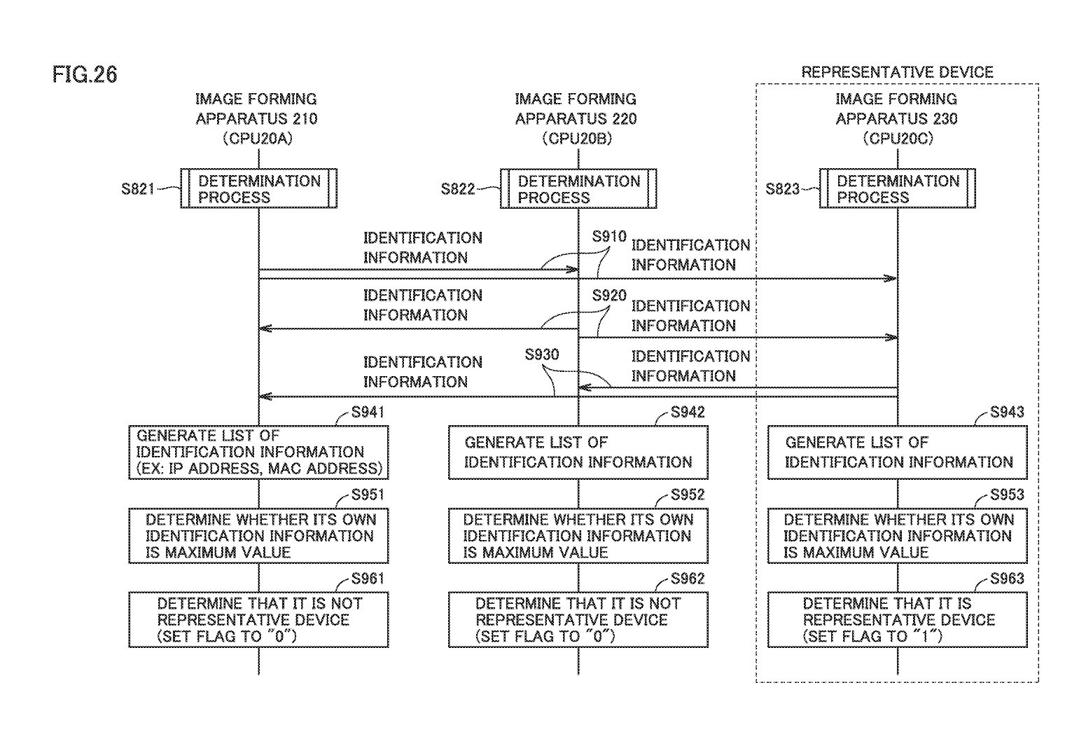

FIG. 26 is a flowchart illustrating the determination process in steps S821 to S823 in FIG. 25. In step S910, CPU 20A, serving as acquisition unit 740, broadcasts the IP address as its own identification information to communication circuit 201. MFPs 220 and 230 thus acquire the IP address of MFP 210.

In step S920, CPU 20B broadcasts its own IP address to communication circuit 201. MFPs 210 and 230 thus acquire the IP address of MFP 220. In step S930, CPU 20C broadcasts its own IP address to communication circuit 201. MFPs 210 and 220 thus acquire the IP address of MFP 230.

In steps S941 to S943, CPU 20 of each MFP 200, serving as determination unit 720, generates a list of identification information (IP address) of each MFP 200. In steps S951 to S953, each CPU 20, serving as determination unit 720, determines whether the MFP itself is a representative device based on the list of identification information. In the example in FIG. 26, each CPU 20 determines that the MFP itself is a representative device if the identification information (IP address) of the MFP itself is the maximum value. In another aspect, each CPU 20 may be configured to determine that the MFP itself is a representative device when its own identification information is the minimum value.

In step S961, CPU 20A determines that MFP 210 is not a representative device and sets flag 234 to “0”. In step S962, CPU 20B determines that MFP 220 is not a representative device and sets flag 234 to “0”. In step S962, CPU 20C determines that MFP 230 is a representative device and sets flag 234 to “1”. MFP 200 with flag 234 set to “0” does not transmit the change information to PC 300.

According to the description above, system 1 according to an embodiment is configured such that only the MFP 200 that is determined to be a representative device transmits the change information and the identification information of each MFP 200 to PC 300. System 1 thus can suppress a traffic increase in network 400 between MFPs 200 and PC 300 when access information 361 of PC 300 is updated due to a change in setting information 231 of MFP 200. Supposing that each of MFPs 200 transmits the change information to PC 300, PC 300 need to perform the process of updating access information 361 every time it receives the change information. This increases processing burden on PC 300. By contrast, PC 300 according to the embodiment can receive data for updating access information 361 collectively from one MFP 200 (representative device), which can reduce the burden of updating access information 361 and the burden of managing access information 361.

In the example above, each MFP 200 treats the IP address as identification information. Alternatively, in another aspect, the MAC (Media Access Control) address set for communication I/F 27 may be treated as identification information, in place of IP address. IP address may be dynamically changed. For this reason, PC 300 may try but fail to access MFP 200 in accordance with the received IP address or may access MFP 200 different from MFP 200 originally intended. By contrast, MAC address is basically not changed. This ensures that PC 300 accesses MFP 200 in accordance with MAC address.

(Process 2)

In the example above, each MFP 200 is configured to determine whether the MFP itself is a representative device (steps S821 to S823 in FIG. 26). In system 1 according to an embodiment, one MFP 200 of a plurality of MFPs 200 performs the process of specifying a representative device.

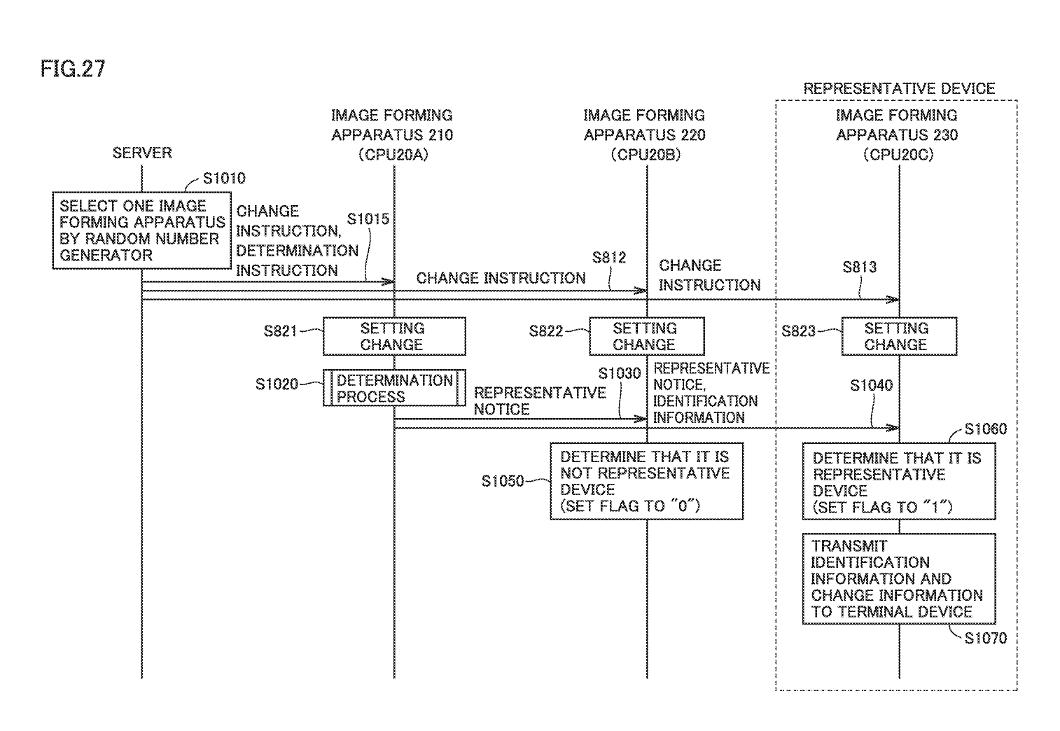

FIG. 27 is a flowchart illustrating a process in system 1 according to an embodiment. In FIG. 27, the same processing as the processing in FIG. 25 is denoted by the same reference sign and a description thereof will not be repeated.

In step S1010, server 100 selects one MFP 200 from among MFPs 210 to 230 using a random number generator. In the example in FIG. 27, server 100 selects MFP 210. In another aspect, the user may select one MFP 200 from among MFPs 210 to 230 in advance, and server 100 may be configured to store the selected MFP 200 into HDD 13.

In step S1015, server 100 transmits a change instruction and a determination instruction to the selected MFP 210. In step S1020, CPU 20A determines which of a plurality of MFPs 200 is a representative device, in accordance with input of the determination instruction from server 100. In the example in FIG. 27, CPU 20A determines that MFP 230 is a representative device.

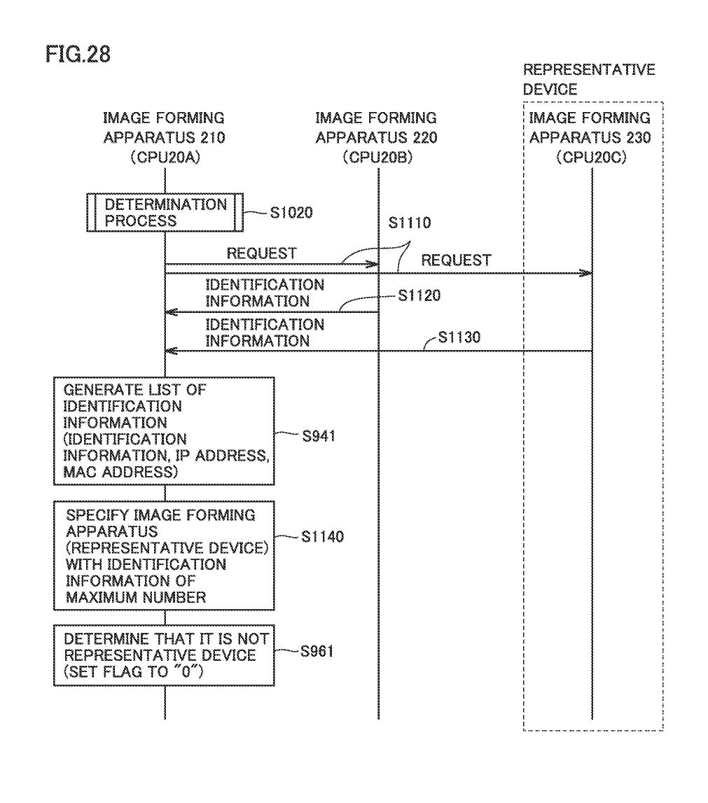

In step S1030, CPU 20A transmits a representative notice indicating that MFP 230 is a representative device to MFP 220. In step S1040, CPU 20A transmits a representative notice and the identification information of each MFP 200 to MFP 220. CPU 20A acquires the identification information of each MFP 200 through the processing in steps S1110 to 1130 in FIG. 28 as will be described later.

In step S1050, CPU 20B determines that MFP 220 is not a representative device and sets flag 234 to “0”. In step S1060, CPU 20C determines that MFP 230 is a representative device and sets flag 234 to “1”. In other words, MFPs 220 and 230 can determine whether the MFPs themselves are a representative device, based on the representative notice received from MFP 210. In step S1070, CPU 20C, serving as notification unit 730, transmits the change information and the identification information of each MFP 200 to PC 300.

FIG. 28 is a flowchart illustrating the process in step S1020 in FIG. 27. In FIG. 28, the same processing as the processing in FIG. 26 is denoted by the same reference sign and a description thereof will not be repeated.

In step S1110, CPU 20A broadcasts a request for identification information to communication circuit 201. In step S1120, in response to the received request, CPU 20B transmits the identification information of MFP 220 to MFP 210. In step S1130, in response to the received request, CPU 20C transmits the identification information of MFP 230 to MFP 210.

In step S1140, CPU 20A specifies a representative device based on the acquired identification information of each MFP 200. In the example in FIG. 28, CPU 20A specifies that the device having the maximum value among the acquired identification information of MFPs 200 is MFP 230.

According to the description above, in system 1, one MFP 200 of a plurality of MFPs 200 specifies a representative device. That is, it is not necessary that a plurality of MFPs 200 should exchange their own identification information by broadcast. Therefore, system 1 according to an embodiment can suppress a traffic increase in communication circuit 201 and alleviate the burden of processing in each MFP 200, compared with the foregoing system 1.

In the example above, MFP 200 selected by server 100 is configured to specify a representative device. Alternatively, in another aspect, system 1 may be configured to specify MFP 200 selected by server 100 as a representative device.

(Process 3)

In the example above, one MFP 200 is configured to request identification information from other MFPs 200 (step S1110 in FIG. 28). In system 1 according to an embodiment, server 100 is configured to transmit the identification information of each MFP 200 to one MFP 200.

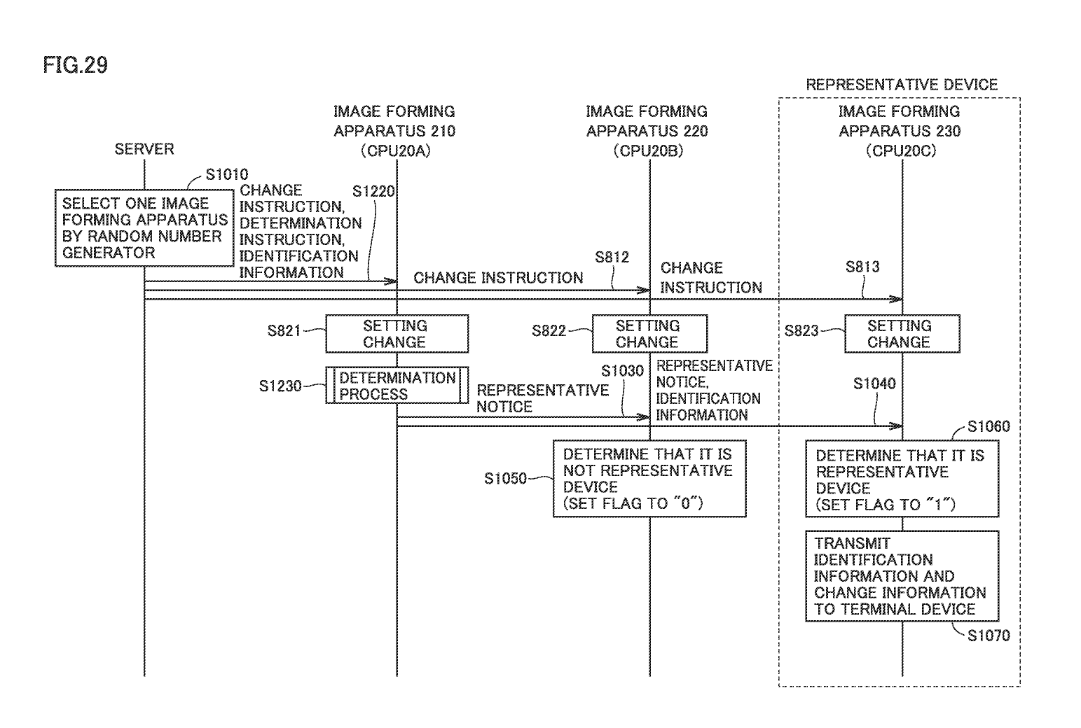

FIG. 29 is a flowchart illustrating a process in system 1 according to an embodiment. In FIG. 29, the same processing as the processing in FIG. 27 is denoted by the same reference sign and a description of such processing will not be repeated.

In step S1220, server 100 further transmits the identification information of each MFP 200 stored in HDD 13, in addition to a change instruction and a determination instruction, to MFP 210 selected from among a plurality of MFPs 200. In another aspect, server 100 may be configured to transmit only the identification information of MFP 200 to which a change instruction is transmitted, among the identification information of MFPs 200 stored in HDD 13. In the example in FIG. 29, server 100 transmits a change instruction to all the MFPs 200 connected to network 400. In another aspect, a change instruction may be transmitted only to some of MFPs 200. In such a case, server 100 may transmit only the identification information of MFP 200 to which a change instruction has been transmitted, to the selected MFP 210. MFP 210 thus can grasp MFP 200 in which setting information 231 is to be changed, among a plurality of MFPs 200 connected to network 400.

In step S1230, CPU 20A determines which of a plurality of MFPs 200 is a representative device, in accordance with input of a determination instruction from server 100.

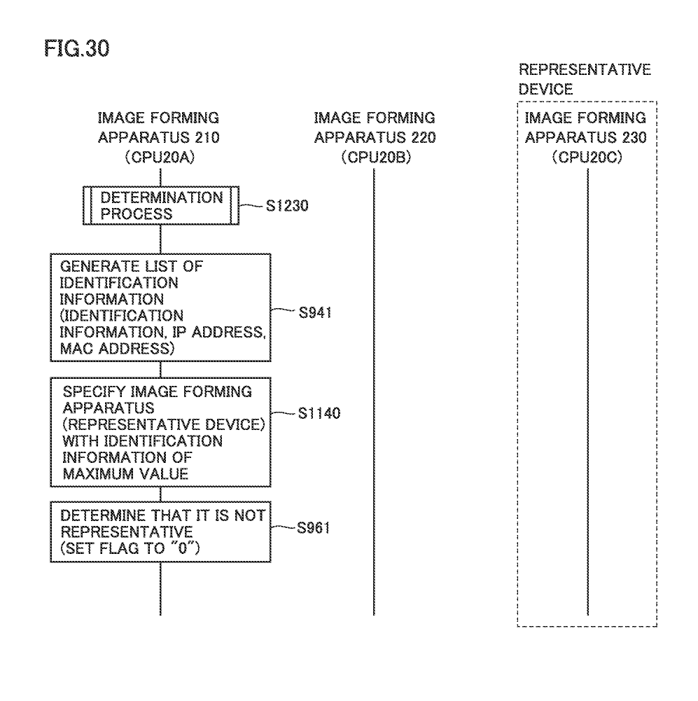

FIG. 30 is a flowchart illustrating the processing in step S1230 in FIG. 29. The processing in step S1230 differs from the processing in step S1020 described in FIG. 28 in that it does not include the processing in steps S1110 to S1130.

According to the description above, in system 1, since server 100 transmits the identification information of each MFP 200 to MFP 210, MFP 210 need not perform the processing of communicating with other MFPs 200 to acquire identification information (steps S1110 to S1130). Accordingly, system 1 according to an embodiment can alleviate the burden of processing in each MFP 200, compared with the foregoing system 1.

(Process 4)

In the example above, MFP 200 is configured to specify a representative device. In an embodiment, server 100 is configured to specify a representative device.

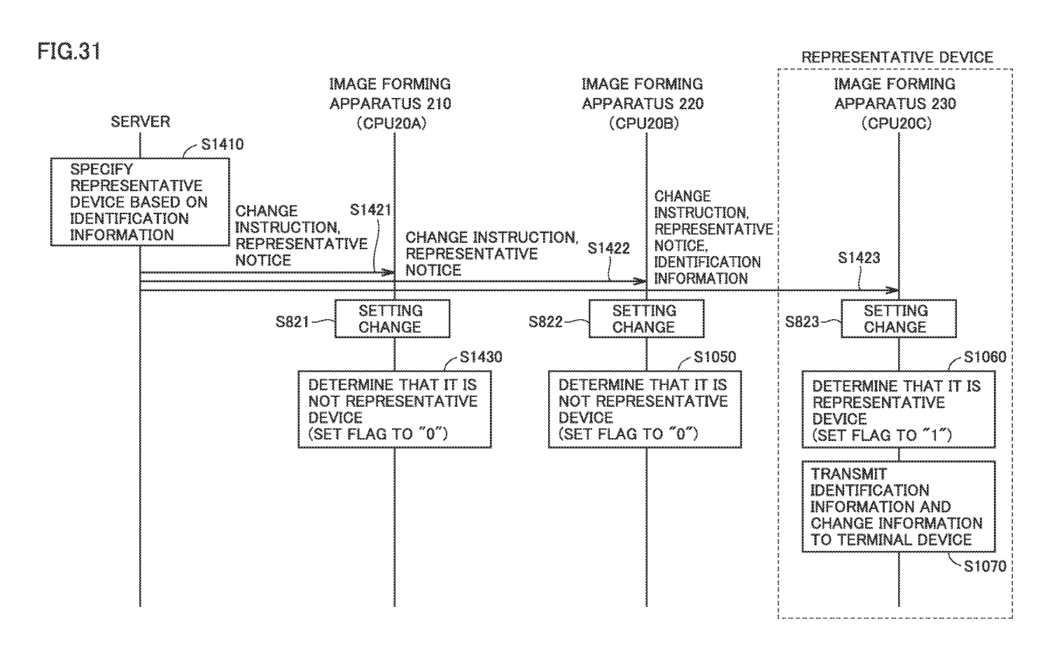

FIG. 31 is a flowchart illustrating a process in system 1 according to an embodiment. In FIG. 31, the same processing as the processing in FIG. 27 is denoted by the same reference sign and a description thereof will not be repeated.

In step S1410, server 100 specifies a representative device based on the identification information of each MFP 200 stored in HDD 13. This specifying method is the same as the method described above and a description thereof will not be repeated. Server 100 specifies that MFP 230 is a representative device.

In steps S1421 and S1422, server 100 transmits a change instruction and a representative notice indicating that MFP 230 is a representative device to MFPs 210 and 220. In step S1430, CPU 20A determines that MFP 210 is not a representative device and sets flag 234 to “0”.

In step S1423, server 100 transmits a change instruction, a representative notice, and the identification information of each MFP 200 to MFP 230. In step S1070, CPU 20C then transmits the identification information and the change information to PC 300.

According to the description above, in system 1, since server 100 specifies a representative device, the burden of processing of specifying a representative device to MFP 200 can be alleviated.

(Process 5)

In the example above, a representative device is configured to transmit the change information and the identification information to PC 300. However, the representative device may fail to transmit these pieces of information to PC 300 for some reasons. In such a case, system 1 according to an embodiment selects the next representative device, and the next device transmits these pieces of information to PC 300.

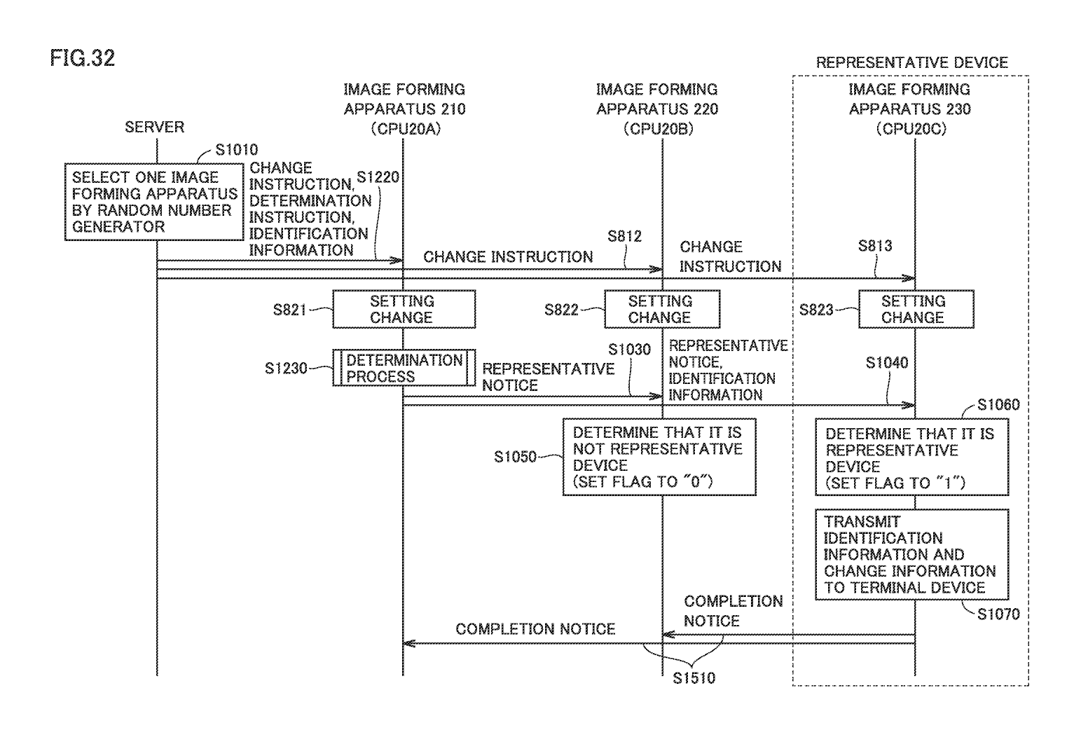

FIG. 32 is a flowchart (1) illustrating a process in system 1 according to an embodiment. In FIG. 32, the same processing as the processing in FIG. 27 is denoted by the same reference sign and a description thereof will not be repeated.

In step S1510, MFP 230 serving as a representative device broadcasts, to communication circuit 201, a completion notice indicating that the change information and the identification information of each MFP 200 have been transmitted to PC 300. MFPs 210 and 220 thus grasp that the representative device has transmitted these pieces of information to PC 300.

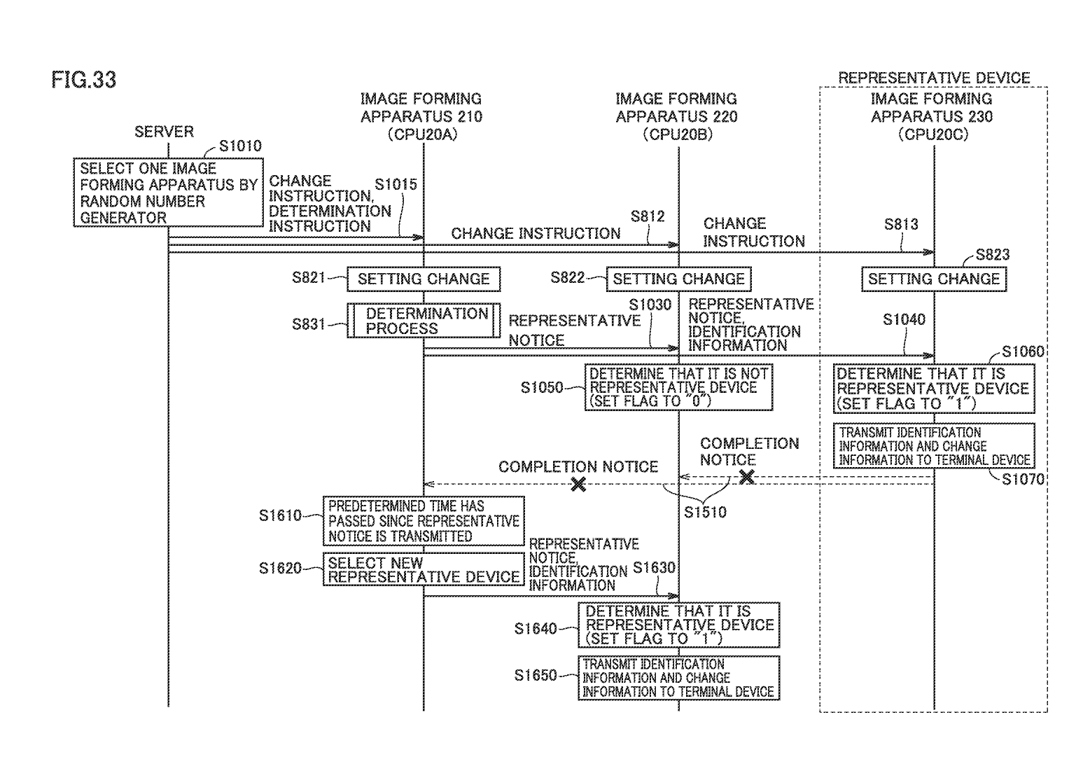

FIG. 33 is a flowchart (2) illustrating a process in system 1 according to an embodiment. In FIG. 33, the same processing as the processing in FIG. 27 is denoted by the same reference sign and a description thereof will not be repeated.

In the example in FIG. 33, MFP 230 serving as a representative device fails to transmit the change information and the identification information of each MFP 200 to PC 300 in step S1070, due to a failure of communication I/F 27 or other reasons. A completion notice is thus not transmitted from MFP 230 to MFPs 210 and 220.

In step S1610, CPU 20A of MFP 210 determines that a predetermined time (for example, five seconds) has passed without receiving a completion notice from MFP 230 since a representative notice is transmitted in S1040.

In step S1620, CPU 20A selects a new representative device different from MFP 230 from among a plurality of MFPs 200, in response to the elapse of a predetermined time without receiving a completion notice. As an example, CPU 20A selects a device having the largest identification information (IP address) from among MFPs 200 excluding MFP 230, as a representative device. In the example in FIG. 33, CPU 20A selects MFP 220 as a new representative device.

In step S1630, CPU 20A transmits a representative notice indicating that MFP 220 is a representative device and the identification information of each MFP 200. In step S1640, CPU 20B determines that MFP 220 is a representative device and sets flag 234 to “1”. In step S1650, CPU 20B, serving as notification unit 730, transmits the change information and the identification information of each MFP 200 to PC 300.

According to the description above, in system 1, when a certain representative device fails to transmit the change information and the identification information of each MFP 200 to PC 300 for some reasons, these pieces of information are transmitted from a new representative device to PC 300. This system 1 therefore further ensures that these pieces of information are transmitted to PC 300, compared with the foregoing system 1.

(Process 6)

The system described above is configured to specify a representative device based on identification information (for example, IP address or MAC address). The system according to an embodiment is configured to specify a representative device based on the history of communication between each MFP 200 and PC 300.

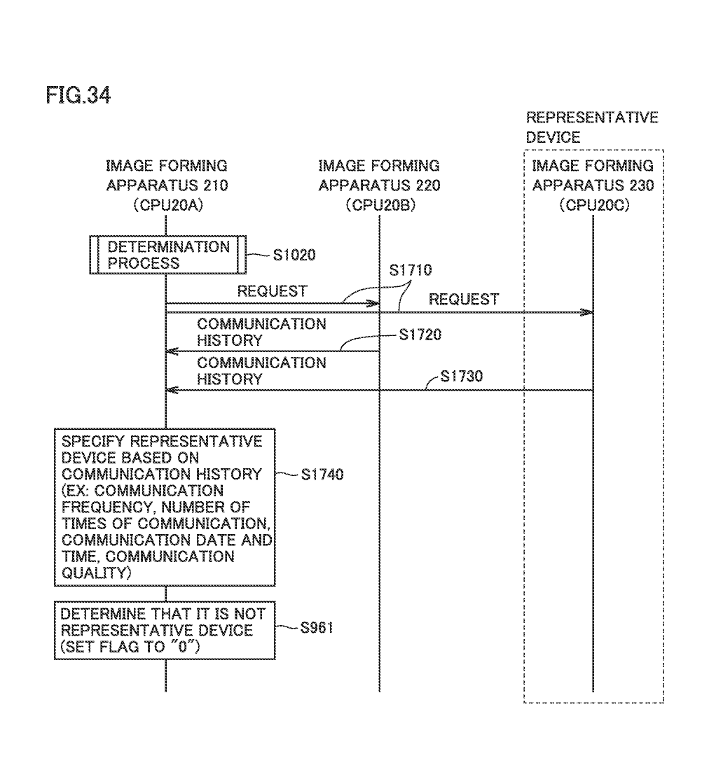

FIG. 34 is a flowchart illustrating the processing in step S1020 in FIG. 27 according to an embodiment. In FIG. 34, the same processing as the processing in FIG. 28 is denoted by the same reference sign and a description thereof will not be repeated.

In step S1710, CPU 20A broadcasts a request for the history of communication with PC 300 to communication circuit 201. In step S1720, in response to the received request, CPU 20B extracts the communication history corresponding to the IP address of PC 300 from communication history 232 and transmits the extracted communication history to MFP 210. In step S1730, CPU 20C extracts the history of communication with PC 300 from communication history 232 and transmits the extracted communication history to MFP 210, in the same manner as CPU 20B. As described in FIG. 22, the communication history includes the communication date and time and the success/failure information.

In step S1740, CPU 20A, serving as determination unit 720, specifies a representative device based on the history of communication between each MFP 200 and PC 300.

(Communication Frequency)

In an aspect, CPU 20A specifies a device with the highest frequency of communication with PC 300, as a representative device, from among a plurality of MFPs 200. As an example, CPU 20A specifies a device with the highest frequency of communication in a predetermined period (for example, the past one month).

(Access Count)

In another aspect, CPU 20A specifies a device that accesses PC 300 most frequently, as a representative device, from among a plurality of MFPs 200.

(Communication Date and Time)

In yet another aspect, CPU 20A specifies a representative device based on the date and time of communication with PC 300. For example, CPU 20A specifies MFP 200 that has communicated with PC 300 most recently, as a representative device. As another example, CPU 20A specifies MFP 200 having a communication record of the earliest communication date and time, that is, MFP 200 that communicated with PC 300 first, as a representative device.

(Communication Quality)

In yet another aspect, CPU 20A specifies a representative device based on the quality of communication with PC 300. For example, CPU 20A specifies MFP 200 with the highest success ratio of communication with PC 300 (the ratio of the number of times of success to the number of times of communication) as a representative device. As another example, when each MFP 200 and PC 300 perform wireless communication, CPU 20A specifies MFP 200 with the highest receiving sensitivity of radio waves emitted by PC 300, as a representative device. In this case, MFPs 220 and 230 are configured to transmit information of the receiving sensitivity to MFP 210. In this configuration, system 1 can select MFP 200 with the highest possibility that the change information and the like can be transmitted to PC 300, as a representative device.

(Process 7)

The system according to an embodiment specifies a representative device based on the device information of each MFP 200.

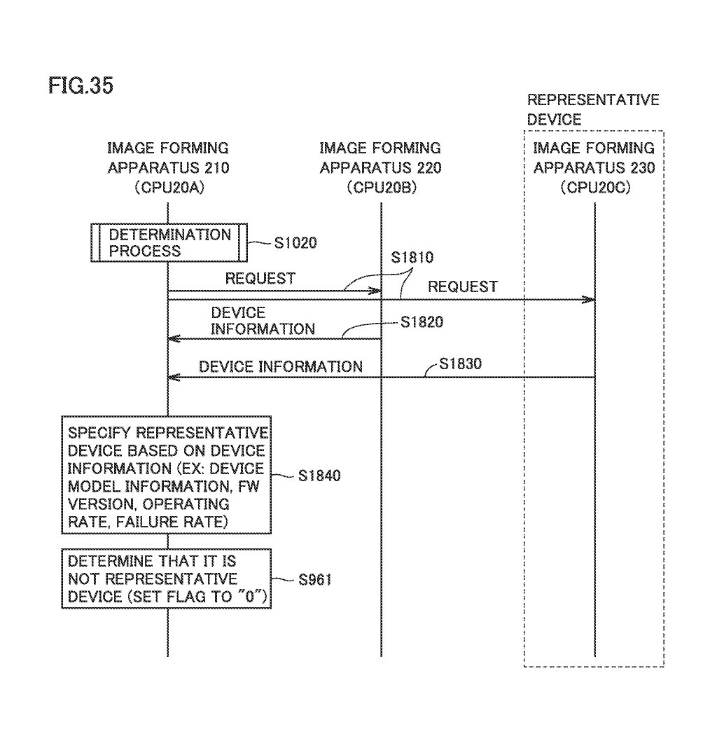

FIG. 35 is a flowchart illustrating the processing in step S1020 in FIG. 27 according to an embodiment. In FIG. 35, the same processing as the processing in FIG. 28 is denoted by the same reference sign and a description thereof will not be repeated.

In step S1810, CPU 20A broadcasts a request for device information 233 to communication circuit 201. In step S1720, in response to the received request, CPU 20B transmits device information 233 to MFP 210. In step S1730, CPU 20C transmits device information 233 to MFP 210 in the same manner as CPU 20B. As described in FIG. 23, device information 233 includes device model information, FW version information, operating rate, and failure rate.

In step S1740, CPU 20A, serving as determination unit 720, specifies a representative device based on device information 233 of each MFP 200.

(Device Model Information)

In an aspect, CPU 20A specifies MFP 200 of the latest model as a representative device based on the device model information included in device information 233 of each MFP 200. In this case, the device model information of device information 233 may include information of the release date of the product.

(Firmware Version Information)

In another aspect, CPU 20A specifies MFP 200 with FW of the latest version as a representative device, based on the FW version information included in device information 233 of each MFP 200.

(Operating Rate)

In yet another aspect, CPU 20A specifies MFP 200 with the highest operating rate as a representative device, based on the operating rate included in device information 233 of each MFP 200.

(Failure Rate)

In yet another aspect, CPU 20A specifies MFP 200 with the lowest failure rate as a representative device, based on the failure rate included in device information 233 of each MFP 200.

According to the description above, system 1 may specify the device with the highest possibility of success in communication with PC 300 as a representative device, based on the device information of each MFP 200.

These parameters may be used similarly in the foregoing processing.

(Other Configurations)

In the foregoing example, system 1 includes server 100 and PC 300. In another aspect, system 1 may include only one of server 100 and PC 300. For example, when system 1 includes only PC 300, PC 300 is configured to store RDT 10A and access information 361.

In the foregoing example, system 1 is configured to specify one MFP 200 as a representative device from among a plurality of MFPs 200. Alternatively, in another aspect, system 1 may be configured to specify a plurality of representative devices. In this case, each of a plurality of representative devices is configured to transmit the change information and the identification information of each MFP 200 to PC 300. This further ensures that PC 300 receives these pieces of information.

In the foregoing example, system 1 is configured to specify a representative device based on one of identification information, communication history, and device information. Alternatively, system 1 may be configured to specify a representative device based on a combination of these pieces of information. As an example, when system 1 determines that there are a plurality of MFPs 200 of the latest model, the device with the largest IP address of the IP addresses of a plurality of MFPs 200 may be specified as a representative device.

[Traffic Control 2]

(Related Art)

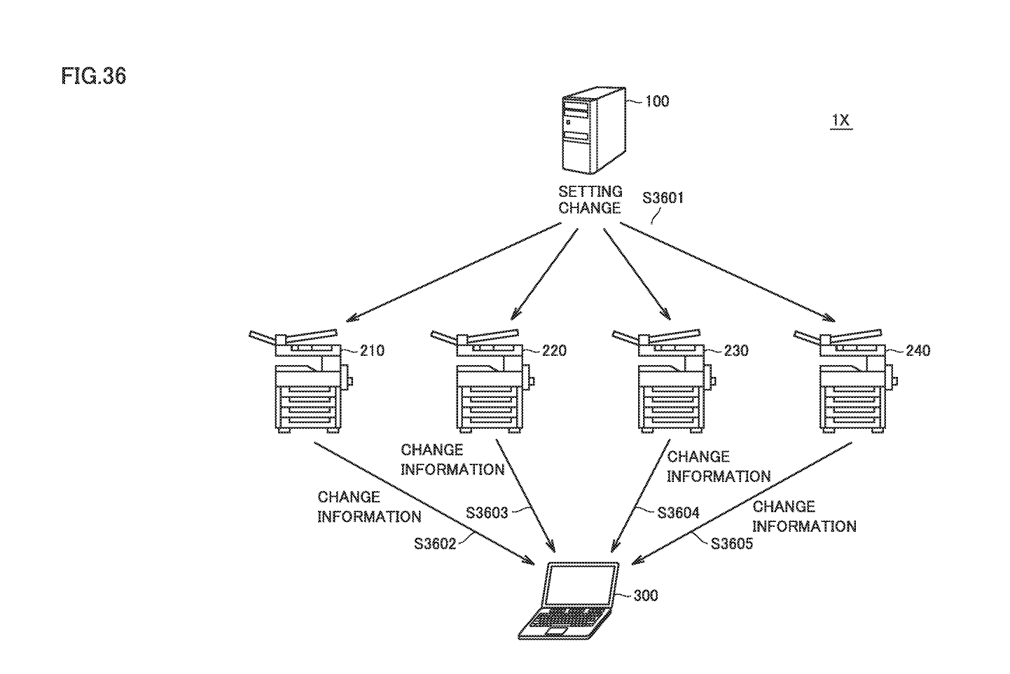

FIG. 36 is a diagram for explaining a process in an information processing system 1X according to a related art. Information processing system 1X includes a server 100, MFPs 210 to 240, and a PC 300. MFPs 210 to 240 may hereinafter be collectively referred to as “MFP 200”. Server 100 as an external device stores an application for changing the settings of MFP 200. PC 300 stores an application for collaborating with MFP 200. PC 300 may execute this application to establish communication with MFP 200 and transmit a scan instruction and the like to MFP 200.

In an aspect, server 100 transmits an instruction to change the settings of MFP 200 to MFPs 210 to 240 (step S3601). The content of the instruction transmitted to each MFP 200 is the same. As an example, server 100 transmits an instruction to change the password of each MFP 200 to “ABCDE”. Each of MFPs 210 to 240 changes the settings in accordance with the received instruction. Each of MFPs 210 to 240 transmits the change information indicating the content of the changed settings to PC 300 (steps S3602 to S3605).

PC 300 updates information necessary for collaborating with these MFPs 200 (which hereinafter may be referred to as “collaboration information”), based on the change information received from each of MFPs 210 to 240. PC 300 thus can collaborate with MFP 200 even when the settings of MFP 200 are changed. PC 300 stores collaboration information for each of a plurality of MFPs 200 to collaborate with.

Unfortunately, information processing system 1X according to a related art is configured such that each of a plurality of MFPs 200 having the settings changed transmits the change information to PC 300, and therefore the traffic in the network thereof is heavy. An information processing system 1 according to an embodiment can solve this problem.

(Process Overview)

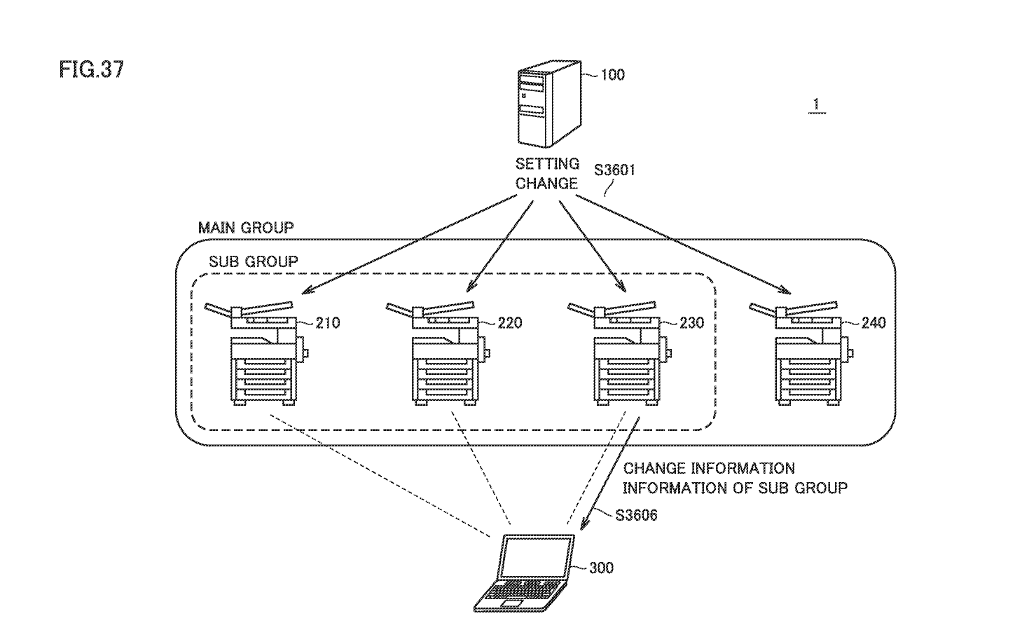

FIG. 37 is a diagram for explaining a process in information processing system 1 according to an embodiment. In FIG. 37, the same elements as the elements in FIG. 36 are denoted by the same reference signs and a description thereof will not be repeated.

Information processing system 1 according to an embodiment determines whether it is necessary to notify PC 300 of the change information. More specifically, if PC 300 becomes unable to collaborate with MFP 200 due to a setting change, information processing system 1 determines that it is necessary to notify PC 300 of the change information.

If it is determined that notification of the change information is necessary, information processing system 1 specifies a sub-group including at least two or more MFPs 200, from a main group including MFPs 210 to 240 that have accepted a setting change instruction from server 100 (the image forming apparatuses to be subjected to the same setting change). In the example in FIG. 37, server 100 transmits a setting change instruction to all the MFPs 200 included in information processing system 1. However, in another aspect, this instruction may be transmitted to some of MFPs 200.

In an aspect, information processing system 1 forms a sub-group with MFPs 200 that have communicated with PC 300. In the example in FIG. 37, information processing system 1 forms a sub-group with MFPs 210 to 230.

Information processing system 1 transmits the change information and information of MFP 200 belonging to the sub-group from MFP 200 (in FIG. 37, MFP 230) belonging to the sub-group to PC 300 (step S6). PC 300 updates the collaboration information for collaborating with MFP 200 belonging to the sub-group, based on the received information.

According to the description above, PC 300 only has to communicate with MFP 200 belonging to the sub-group to update the collaboration information. Accordingly, information processing system 1 according to the embodiment can suppress a network traffic increase, compared with information processing system 1X according to a related art.

(Process 1)

<Formation of Sub-Group>

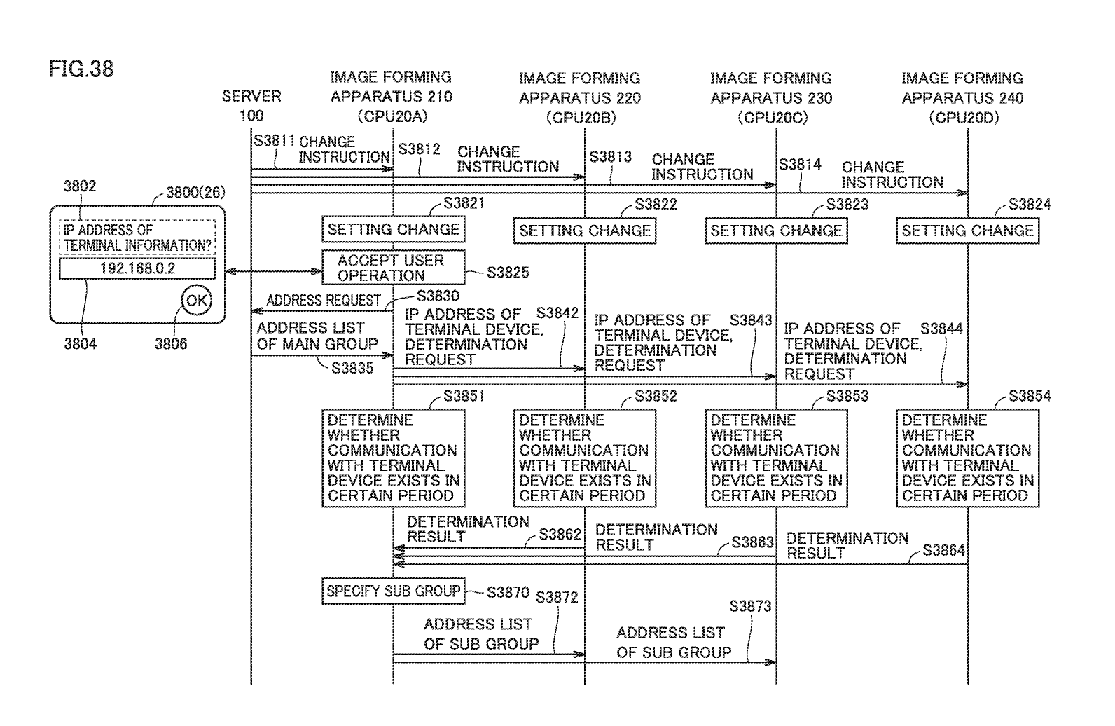

FIG. 38 is a flowchart illustrating a process of forming a sub-group in information processing system 1 according to an embodiment. Each processing shown in FIG. 38 may be implemented by CPU 10 of server 100 executing a control program stored in ROM 11 and by CPU 20 of MFP 200 executing a control program stored in ROM 21. In another aspect, part or the whole of the process may be implemented by a circuit element or other hardware.

In steps S3811 to S3814, CPU 10 of server 100 transmits a change instruction to each of MFPs 210 to 240 in accordance with RDT 10A. The content of the instruction transmitted to each MFP 200 is the same. In steps S3821 to S3824, CPU 20 of each MFP 200 updates setting information 231 in accordance with the received change instruction.

In step S3825, MFP 210 accepts operation from a user. As an example, CPU 20A of MFP 210 displays a screen 3800 shown in FIG. 38 on operation panel 26 through predetermined user operation input through operation panel 26. Screen 3800 includes a message 3802 for prompting for input of the IP address of PC 300, an entry form 3804, and an OK button 3806. The user views screen 3800, inputs the IP address of PC 300 in entry form 3804, and then presses OK button 3806. In step S3830, CPU 20A transmits an address request to server 100 in response to pressing OK button 3806. In step S3835, server 100 transmits a list of IP addresses of MFPs 210 to 240 included in the main group to MFP 210. In another aspect, each MFP 200 may store a list of IP addresses of MFPs 200 belonging to the main group in HDD 23 in advance. In such a case, the processing in steps S3830 and S3835 may be omitted.

In steps S3842 to S3844, CPU 20A transmits the IP address of PC 300 and a determination request to MFPs 220 to 240 belonging to the main group.

In step S3851, CPU 20A refers to communication history 232 to determine whether there exists history of communication with PC 300 (the IP address of PC 300) within a predetermined period (for example, one month).

In steps S3852 to S3854, each of CPUs 20B to 20D determines whether there exists history of communication with PC 300 within a predetermined period in accordance with the received determination request, in the same manner as CPU 20A. In steps S3862 to S3864, each of CPUs 20B to 20D transmits the determination result to MFP 210.

In step S3870, CPU 20A specifies MFP 200 determined to have history of communication with PC 300 within a predetermined period, as MFP 200 belonging to a sub-group. In the example in FIG. 38, CPU 20A determines that MFPs 210 to 230 belong to a sub-group.

In steps S3872, S3873, CPU 20A transmits a list of IP addresses of MFPs 210 to 230 belonging to the sub-group to MFPs 220, 230 belonging to the sub-group. MFPs 210 to 230 thus can acquire the identification information of MFPs 200 belonging to the sub-group.

<Collaboration Information-Updating Process>

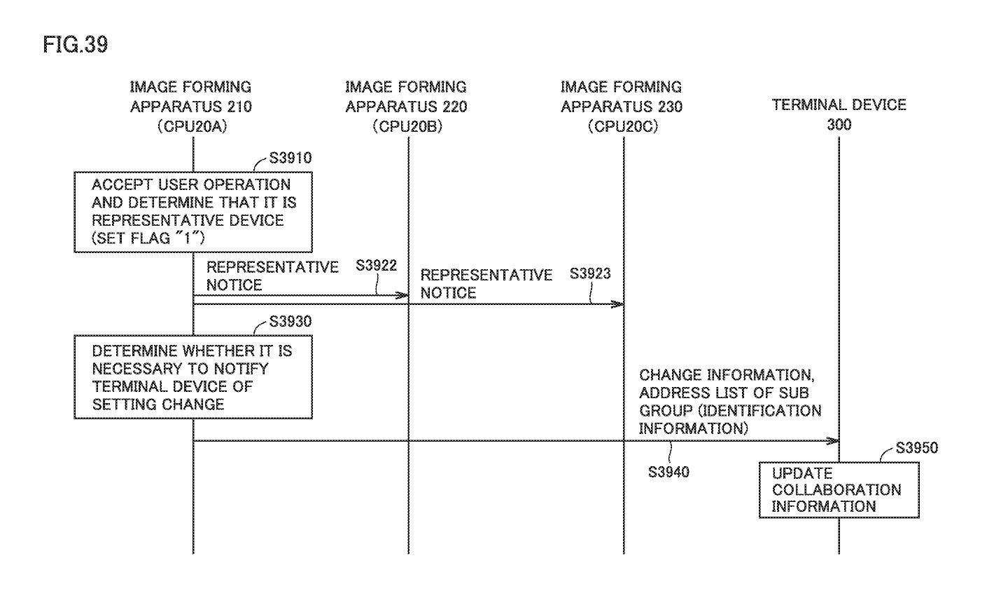

FIG. 39 is a flowchart illustrating a process of updating collaboration information 362 by PC 300 according to an embodiment. In step S3910, CPU 20A of MFP 210 accepts predetermined user operation input through operation panel 26 and determines that MFP 210 itself is a representative device of a plurality of MFPs 200 belonging to the sub-group. CPU 20A sets flag 234 stored in HDD 26 to “1”, in accordance with the determination that MFP 210 itself is a representative device.

In another aspect, CPU 20A may be configured to determine that MFP 210 is a representative device, in accordance with acceptance of input of the IP address of PC 300 on screen 3800 (step S3825). That is, information processing system 1 may select a representative device at a timing when a sub-group is specified.

In steps S3922, S3923, CPU 20A transmits a representative notice indicating that MFP 210 is a representative device to MFPs 220, 230 belonging to the sub-group.

In step S3930, CPU 20A determines whether it is necessary to transmit the change information indicating the content of the setting change made in step S3821 to PC 300. As an example, when a predetermined setting is changed, CPU 20A determines that it is necessary to transmit the change information to PC 300. The predetermined setting is a setting that disables PC 300 to collaborate with MFP 200 when being changed. Examples include the setting of authentication information of MFP 200, the setting about maintenance of MFP 200, the setting of network address of MFP 200, the setting of a control program (for example, firmware) of MFP 200, and the setting of operation schedule of MFP 200. When it is determined that it is not necessary to transmit the change information to PC 300, CPU 20A terminates the process without transmitting the change information to PC 300. Information processing system 1 thus can suppress a traffic increase in a network of MFP 200 and PC 300. MFP 210 serving as a representative device may be configured to notify other MFPs 220 and 230 belonging to the sub-group to indicate that the process ends.

In the example in FIG. 39, CPU 20A determines that it is necessary to transmit the change information to PC 300. In step S3940, CPU 20A transmits the change information and a list of IP addresses of MFPs 200 belonging to the sub-group to PC 300. In step S3950, CPU 30 of PC 300 updates collaboration information 362 corresponding to MFPs 210 to 230, based on the information received from MFP 210.

In step S3940, CPU 20A may transmit other identification information (for example, serial number, MAC address of communication I/F 27) of MFPs 200 belonging to the sub-group to PC 300, in place of a list of IP addresses of MFPs 200 belonging to the sub-group. In this case, in steps S3862 to S3864, MFPs 220 to 240 may be configured to send other identification information together with the determination result to the representative device. Also in this configuration, CPU 30 can update collaboration information 362 corresponding to MFPs 210 to 230.

According to the description above, in information processing system 1 according to an embodiment, the representative device can transmit information of MFP 200 belonging to the sub-group and the change information collectively to PC 300. This eliminates the need for each of MFPs 200 (210 to 240) belonging to the main group to transmit the change information to PC 300. Information processing system 1 thus can suppress a traffic increase in a network of MFP 200 and PC 300, compared with information processing system 1X according to a related art.

<Functional Configuration>

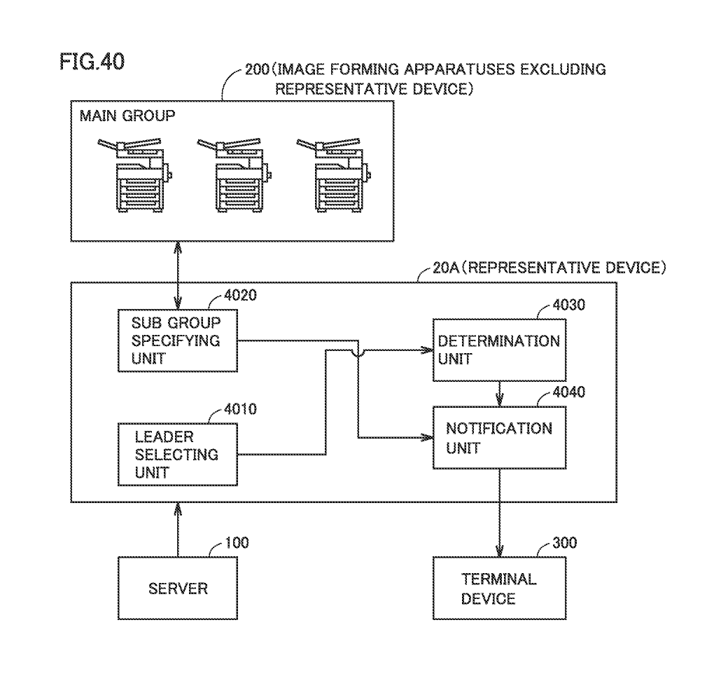

FIG. 40 is a block diagram for explaining a functional configuration of information processing system 1 according to an embodiment. CPU 20A reads and executes a control program to function as a leader selecting unit 4010, a sub-group specifying unit 4020, a determination unit 4030, and a notification unit 4040. CPUs 20 of other MFPs 200 have the similar configuration.

Leader selecting unit 4010 determines whether MFP 210 itself is a representative device. In an aspect, leader selecting unit 4010 determines that MFP 210 itself is a representative device when predetermined user operation is accepted through operation panel 26.

Sub-group specifying unit 4020 specifies a sub-group including at least two or more MFPs 200 from among MFPs 200 belonging to the main group. In an aspect, sub-group specifying unit 4020 specifies MFP 200 communicating with PC 300, as MFP 200 belonging to the sub-group, among MFPs 200 belonging to the main group. In another aspect, sub-group specifying unit 4020 may specify MFP 200 communicating with PC 300 within a predetermined period, as MFP 200 belonging to the sub-group, among MFPs 200 belonging to the main group. In this configuration, information processing system 1 eliminates MFP 200 that communicated with PC 300 outside a predetermined period (a long time ago) from the sub-group, thereby improving security.

Sub-group specifying unit 4020 outputs the identification information (for example, IP address, MAC address, serial number) of MFP 200 belonging to the specified sub-group to notification unit 4040.

In yet another aspect, sub-group specifying unit 4020 may form a sub-group, based on at least one information of installation location information 235 and the network segment of a plurality of MFPs 200 belonging to the main group. As an example, installation location information 235 may be the name and the floor number of the building in which MFP 200 is installed. Sub-group specifying unit 4020 may specify MFP 200 having installation location information 235 that matches installation location information 235 of MFP 210 designated by the user (step S3825 in FIG. 38), as MFP 200 belonging to the sub-group, from among MFPs 200 belonging to the main group. As another example, installation location information 235 may be coordinates information of GPS (Global Positioning System). In this case, sub-group specifying unit 1020 may specify MFP 200 installed within a predetermined distance (for example, 50 m) from the location of MFP 210, as MFP 200 belonging to the sub-group. Sub-group specifying unit 4020 may specify MFP 200 belonging to the same network segment as MFP 210, as MFP 200 belonging to the sub-group.

Determination unit 4030 determines whether it is necessary to transmit the change information to PC 300, in response to acceptance of a notice indicating that MFP 210 itself is a representative device from leader selecting unit 4010. If it is determined that it is necessary to transmit the change information, determination unit 4030 notifies notification unit 4040 of the change information.

Notification unit 4040 accepts a notice from determination unit 4030 and transmits the change information and the identification information of MFP 200 belonging to the sub-group to PC 300.

(Modification)

In the foregoing example, the representative device is configured to transmit the change information and the identification information of MFP 200 belonging to the sub-group to PC 300 when it is determined that it is necessary to notify PC 300 of the change information. The representative device according to a modification may transmit a change notice indicating that setting information 231 has been changed to PC 300 when it is determined that it is necessary to notify PC 300 of the change information. In response, PC 300 requests the change information and information of the image forming apparatus belonging to the sub-group from the representative device.

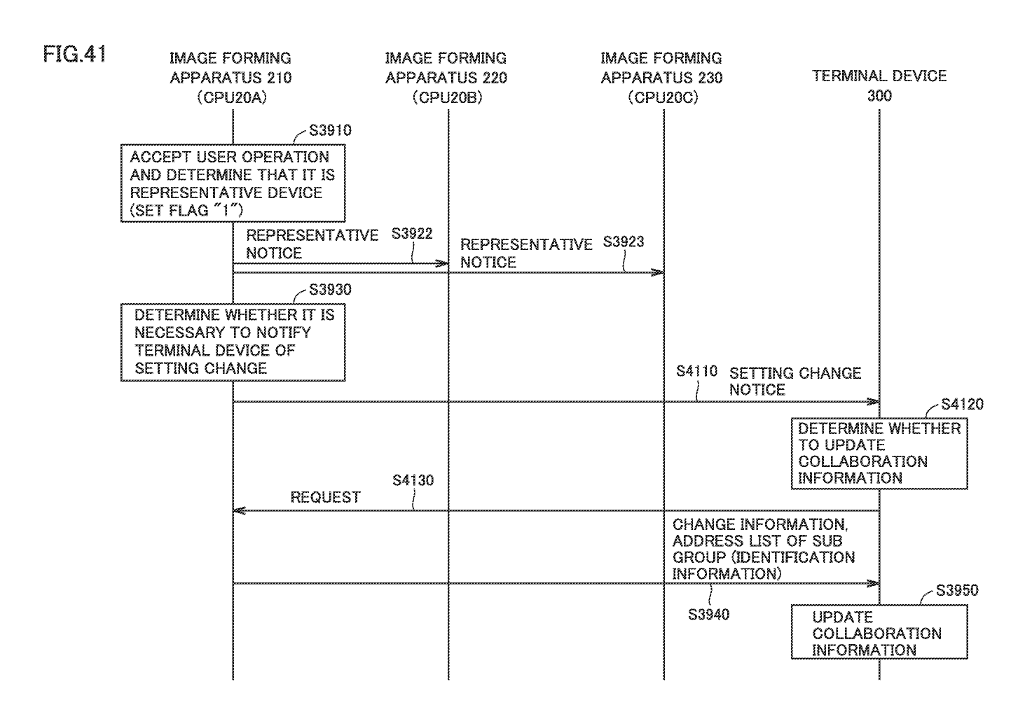

FIG. 41 is a flowchart illustrating a process of updating collaboration information 362 by PC 300 according to a modification. In the process shown in FIG. 41, the same processing as the processing in FIG. 39 is denoted by the same reference sign and a description thereof will not be repeated.

In step S4110, CPU 20A of the representative device transmits a change notice indicating that setting information 231 has been changed to PC 300, in accordance with the determination that it is necessary to notify PC 300 of the change information.

In step S4120, CPU 30 of PC 300 determines whether to update collaboration information 362. In an aspect, CPU 30 determines to update collaboration information 362 when the setting to perform updating is made by a user in advance.

In step S4130, if it is determined to update collaboration information 362, CPU 30 transmits a request to MFP 210 serving as a representative device. In step S3940, in response to the request, CPU 20A transmits the change information and the identification information of MFP 200 belonging to the sub-group to PC 300. Also in this configuration, information processing system 1 can suppress a traffic increase in a network of MFP 200 and PC 300, compared with information processing system 1X according to a related art.

(Process 2)

In the example above, the representative device is configured to transmit a change notice or the change information to PC 300 immediately after it is selected as a representative device. In information processing system 1 according to an embodiment, these pieces of information are transmitted from the representative device to PC 300 at a timing when PC 300 accesses any one of MFPs 200 belonging to the sub-group after the representative device is selected.

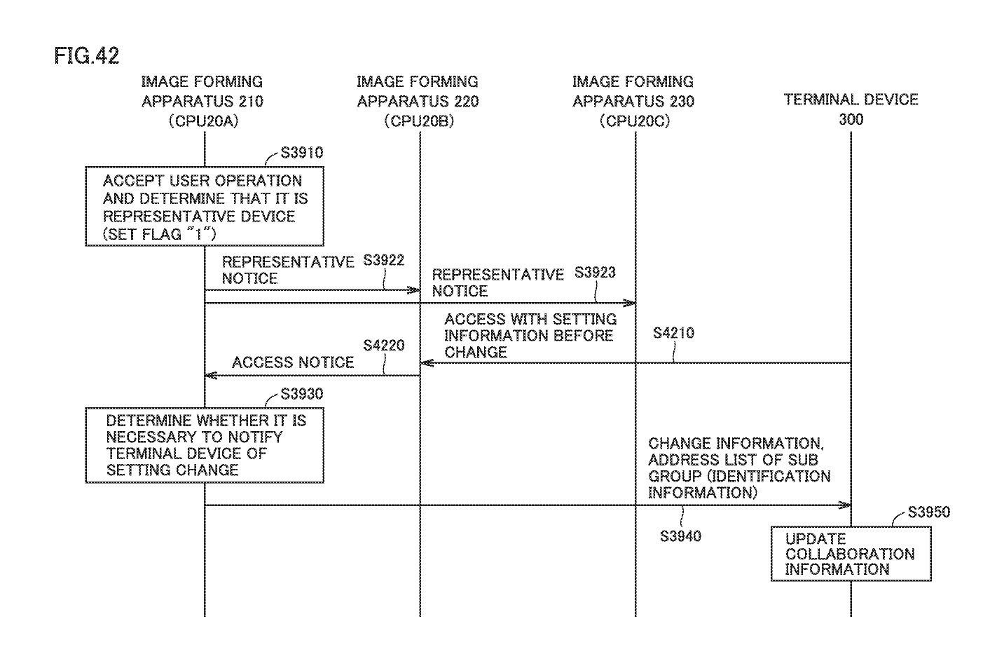

FIG. 42 is a flowchart illustrating a process of updating collaboration information 362 by PC 300 according to an embodiment. In the process shown in FIG. 42, the same processing as the processing in FIG. 39 is denoted by the same reference sign and a description thereof will not be repeated.

In step S4210, PC 300 accesses MFP 220 belonging to the sub-group with setting information 231 before change (setting information 231 before being changed in step S3822). As an example, PC 300 accesses MFP 220 with the password before change. In step S4220, in response to being accessed from PC 300 with setting information 231 before change, CPU 20B of MFP 220 transmits an access notice indicating that PC 300 has accessed, to the representative device. In this case, each CPU 20 may be configured to store setting information 231 in a predetermined period or before a predetermined number of times of change, rather than overwriting and updating setting information 231 in steps S3821 to S3824 in FIG. 38.

If it is determined that it is necessary to transmit the change information to PC 300 (step S3930) in response to reception of the access notice, CPU 20A of the representative device transmits the change information and the identification information of MFP 200 belonging to the sub-group to PC 300 (step S3940).

In this configuration, in information processing system 1 according to an embodiment, collaboration information can be updated at a timing when PC 300 collaborates with MFP 200. In addition, in this information processing system 1, the condition for updating collaboration information 362 is not that PC 300 merely accesses MFP 200 but that it accesses MFP 200 with setting information 231 before change, thereby improving security.

(Process 3)

The foregoing information processing system 1 is configured such that the representative device transmits the change information and the identification information of MFP 200 belonging to the sub-group to PC 300 whereby a network traffic increase is suppressed. Information processing system 1 according to an embodiment is configured such that notification is given from each MFP 200 belonging to the sub-group to PC 300.

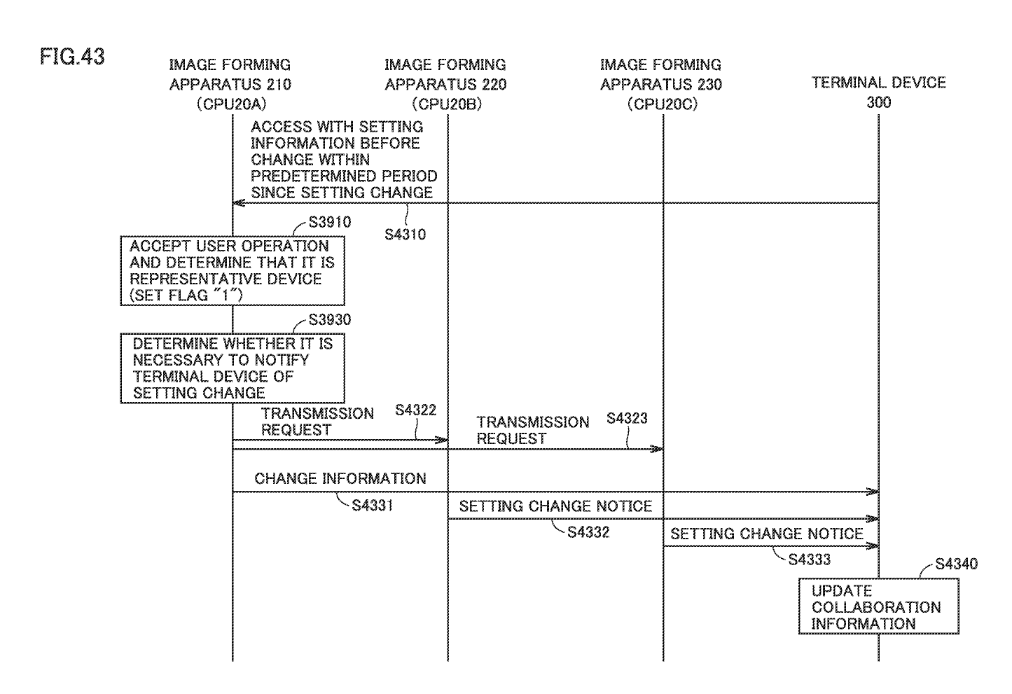

FIG. 43 is a flowchart illustrating a process of updating collaboration information 362 by PC 300 according to an embodiment. In the process shown in FIG. 43, the same processing as the processing in FIG. 39 is denoted by the same reference sign and a description of thereof will not be repeated.

In step S4310, PC 300 accesses MFP 210 belonging to the sub-group with setting information 231 before change (setting information 231 before being changed in step S3821). In step S3910, in response to being accessed from PC 300 with setting information 231 before change, CPU 20A of MFP 210 determines that MFP 210 itself is a representative device.

In steps S4322, S4323, CPU 20A transmits a transmission request to MFPs 220, 230, in accordance with the determination that it is necessary to transmit the change information to PC 300 in step S3930.

In step S4331, CPU 20A transmits the change information. In steps S4332, S4333, CPUs 20B, 20C confirm that flag 234 is set to “0” in response to receiving the transmission request from MFP 210. In other words, CPUs 20B, 20C confirm that MFPs 220, 230 are not a representative device. In response, CPUs 20B, 20C transmit a setting change notice indicating that setting information 231 has been changed to PC 300.

In step S4340, CPU 30 of PC 300 specifies MFP 200 for which collaboration information 362 is to be updated, based on the setting change notice or the IP address of the sender of the change information. CPU 30 then updates collaboration information 362 corresponding to the specified MFP 200, based on the received change information. When CPU 30 specifies MFP 200 with identification information other than the IP address, MFPs 210 to 230 are configured to transmit the identification information together with the change information or the setting change notice in steps S4331 to S4333.

As described above, information processing system 1 according to an embodiment is configured such that each of MFPs 200 belonging to the sub-group communicates with PC 300. Therefore, this information processing system 1 can suppress a network traffic increase, compared with information processing system 1X according to a related art in which each of MFPs 200 belonging to the main group communicates with PC 300.

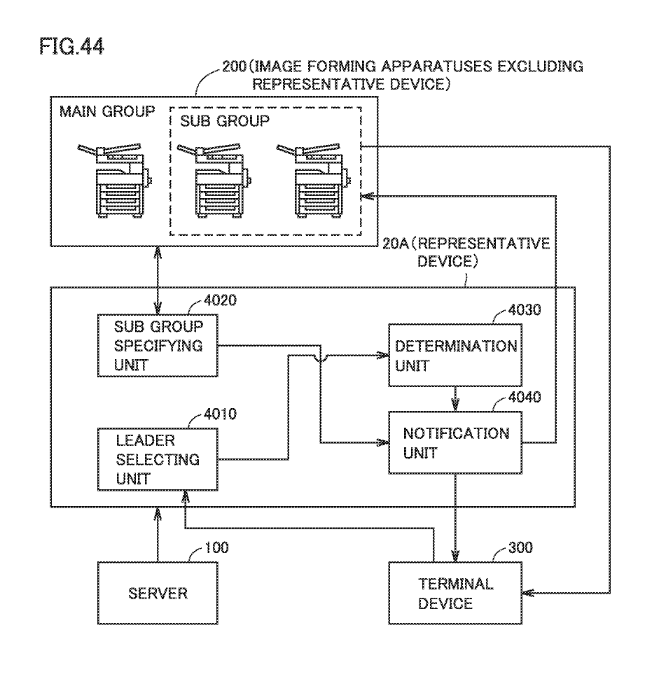

FIG. 44 is a block diagram for explaining a functional configuration of information processing system 1 according to an embodiment. The functional configuration of information processing system 1 according to an embodiment is almost the same as the functional configuration described in FIG. 40 and therefore only the differences will be described.

Leader selecting unit 4010 determines that MFP 210 itself is a representative device, at a timing when PC 300 accesses with the setting information before change. Notification unit 4040 transmits a transmission request to MFP 200 belonging to the sub-group, in accordance with determination unit 4030 determining that it is necessary to transmit the change information to PC 300. MFP 200 belonging to the sub-group that receives the transmission request transmits a setting change notice to PC 300.

(Modification)

In the example above, the representative device is configured to transmit a transmission request to each MFP 200 belonging to the sub-group. In another aspect, server 100 may be configured to transmit a transmission request to each MFP 200 belonging to the sub-group.

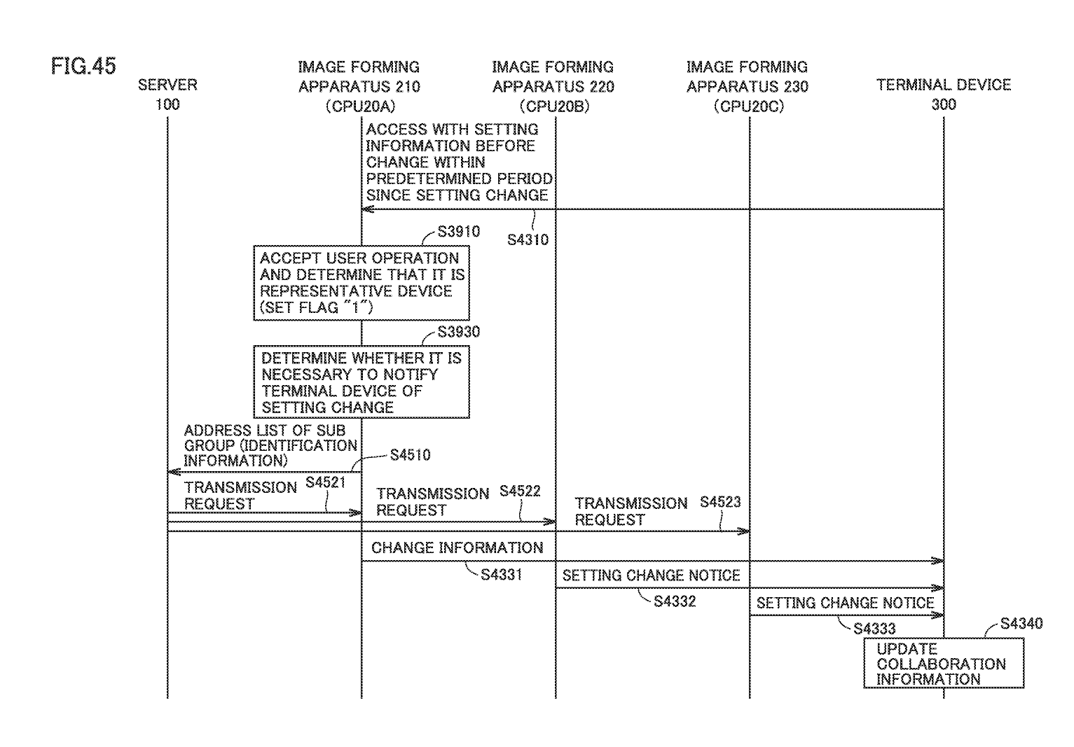

FIG. 45 is a flowchart illustrating a process of updating collaboration information 362 by PC 300 according to a modification. In the process shown in FIG. 45, the same processing as the processing in FIG. 43 is denoted by the same reference sign and a description thereof will not be repeated.

In step S4510, CPU 20A of the representative device transmits the identification information (for example, IP address) of MFP 200 belonging to the sub-group to server 100, in accordance with the determination that it is necessary to transmit the change information to PC 300.

In steps S4521 to S4523, CPU 10 of server 100 transmits a transmission request to each of MFPs 200 belonging to the sub-group, based on the identification information received from the representative device. In step S4331, CPU 20A of the representative device transmits the change information to PC 300, in response to the received transmission request. In steps S4332, S4333, CPUs 20B, 20C transmit a setting change notice to PC 300 in response to reception of the transmission request.

(Process 4)

In the example above, each of MFPs 200 belonging to the sub-group is configured to transmit information to PC 300. In information processing system 1 according to an embodiment, the representative device alone transmits information to PC 300.

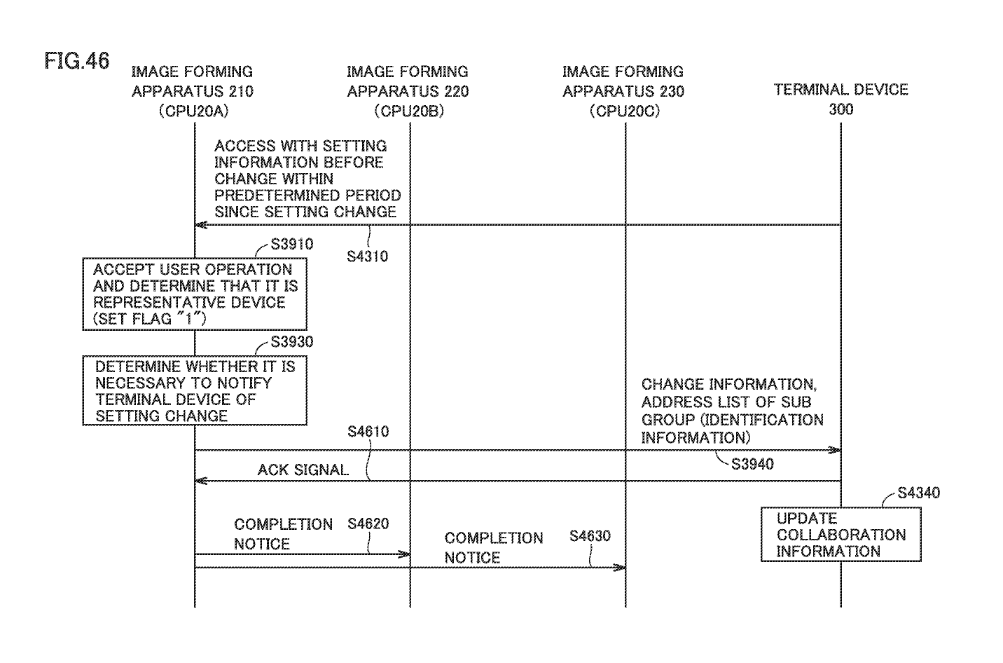

FIG. 46 is a flowchart illustrating a process of updating collaboration information 362 by PC 300 according to an embodiment. In the process shown in FIG. 46, the same processing as the processing in FIG. 43 is denoted by the same reference sign and a description thereof will not be repeated.

In step S3940, CPU 20A of the representative device transmits the change information and the identification information of MFP 200 belonging to the sub-group to PC 300, in accordance with the determination that it is necessary to transmit the change information to PC 300 in step S3930.

In step S4610, PC 300 returns an ACK (ACKnowledgemen) signal to image forming apparatus 210 to indicate that these pieces of information have been received normally from MFP 210 (representative device).

In steps S4620, S4630, CPU 20A transmits a completion notice to MFPs 220, 230 in response to reception of the ACK signal. MFPs 220 and 230, receiving the completion notice, prohibits transmission of the change information to PC 300 when being accessed by PC 300 next time. Information processing system 1 according to an embodiment thus suppresses a traffic increase in a network of these MFPs 200 and PC 300.

(Process 5)

In the foregoing example, information processing system 1 is configured such that any one of a plurality of MFPs 200 selects a representative device. Information processing system 1 according to an embodiment is configured such that PC 300 selects a representative device.

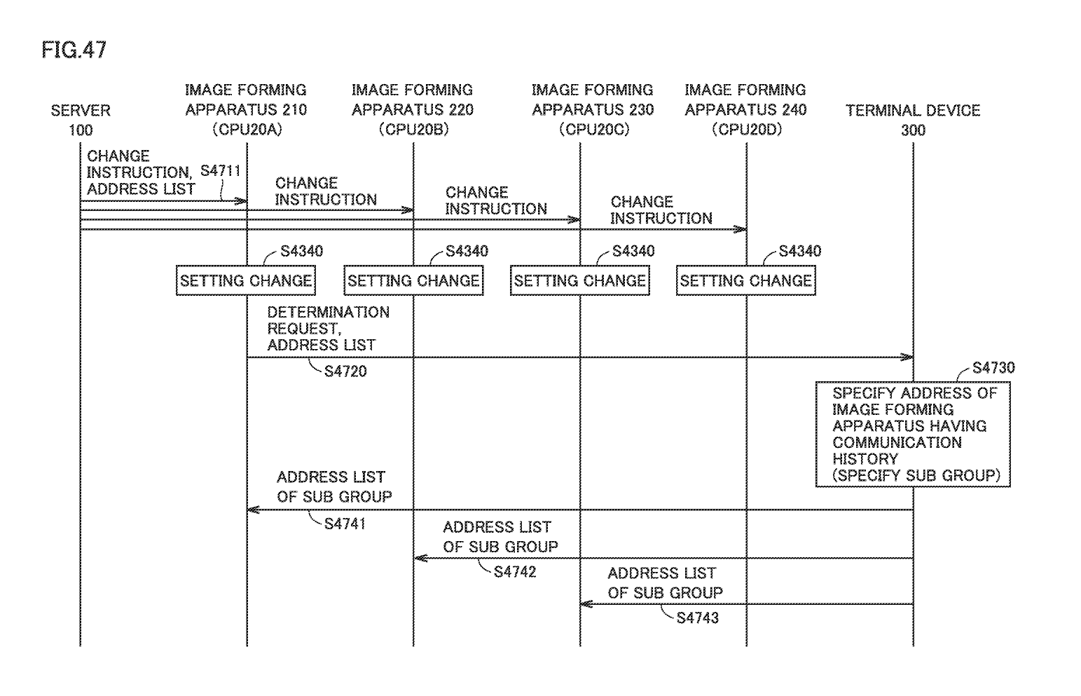

FIG. 47 is a flowchart illustrating a process of forming a sub-group in information processing system 1 according to an embodiment. In the process shown in FIG. 47, the same processing as the processing in FIG. 38 is denoted by the same reference sign and a description thereof will not be repeated.

In step S4711, CPU 10 of server 100 selects one or more MFPs 200 from among MFPs 200 belonging to the main group. In an aspect, CPU 10 selects one or more MFPs 200 at random using a random number generator. In another aspect, CPU 10 selects one or more MFPs 200 in accordance with a predetermined condition (for example, that the user selects the one in advance). In the example in FIG. 47, CPU 10 selects MFP 210.

Furthermore, CPU 10 transmits a change instruction to MFP 210 in accordance with RDT 10A and transmits a list of IP addresses (identification information) of MFPs 200 belonging to the main group.

In step S4720, CPU 20A transmits the received list of IP addresses of MFPs 200 belonging to the main group to PC 300. In step S4730, CPU 30 of PC 300 refers to the communication history stored in HDD 36 to specify MFP 200 having history of communication with PC 300 within a predetermined period, as MFP 200 belonging to the sub-group, from among MFPs 200 belonging to the main group.

In steps S4741 to S4743, CPU 30 transmits a list of IP addresses (identification information) of MFPs 200 belonging to the sub-group to each of MFPs 200 belonging to the sub-group. MFPs 210 to 230 thus can acquire information of MFPs 200 belonging to the sub-group.

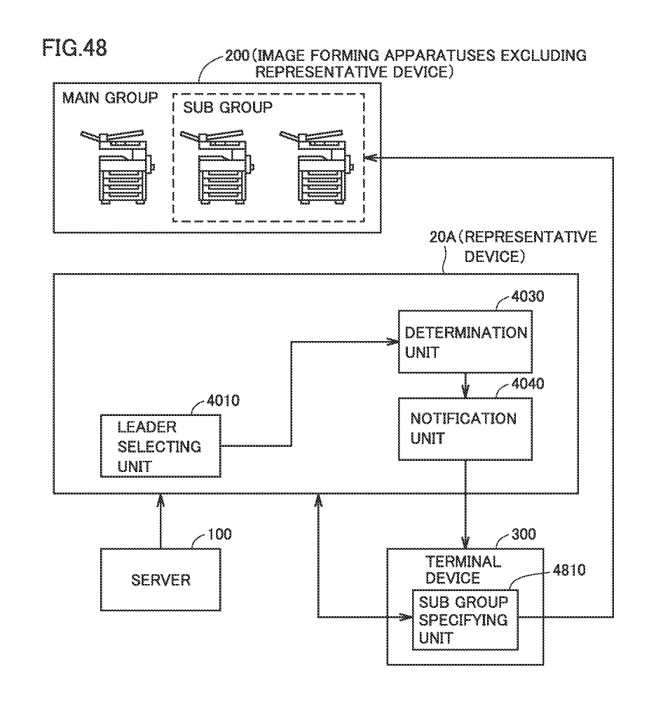

FIG. 48 is a block diagram for explaining a functional configuration of information processing system 1 according to an embodiment. The functional configuration of information processing system 1 is almost the same as the functional configuration described in FIG. 40 and therefore only the differences will be described.

In information processing system 1 according to an embodiment, PC 300 includes a sub-group specifying unit 4810. Sub-group specifying unit 4810 receives a list of IP addresses of MFPs 200 belonging to the main group from MFP 200 (210) designated by server 100 and specifies the sub-group based on the received information. In an aspect, sub-group specifying unit 4810 specifies MFP 200 having communication history with PC 300 as MFP 200 belonging to the sub-group. Sub-group specifying unit 4810 transmits a list of IP addresses of MFPs 200 belonging to the sub-group to each of MFPs 200 belonging to the sub-group.

(Process 6)

In the example above, information processing system 1 is configured such that the change information and the like are directly transmitted from MFP 200 belonging to the sub-group to PC 300. Information processing system 1 according to an embodiment is configured such that the change information and the like are transmitted from MFP 200 belonging to the sub-group to PC 300 via server 100.

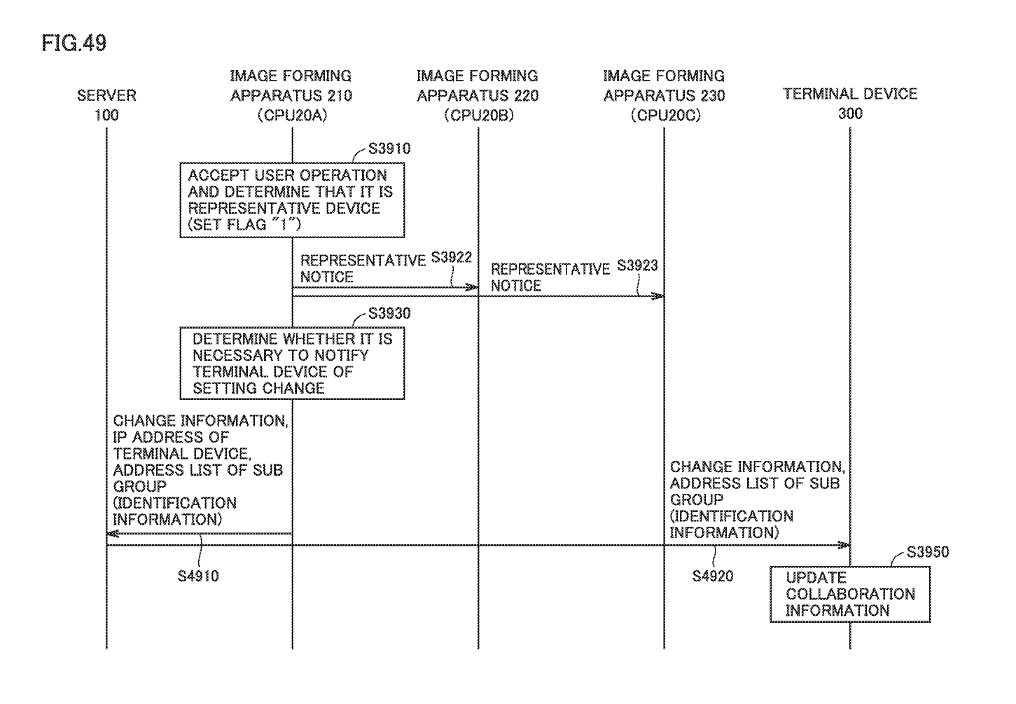

FIG. 49 is a flowchart illustrating a process of updating collaboration information 362 by PC 300 according to an embodiment. In the process shown in FIG. 49, the same processing as the processing in FIG. 39 is denoted by the same reference sign and a description thereof will not be repeated.

In step S4910, CPU 20A of the representative device transmits the change information, the identification information of MFP 200 belonging to the sub-group, and the IP address of PC 300 to server 100, in accordance with the determination that it is necessary to notify PC 300 of the change information.

In step S4920, CPU 10 of server 100 establishes communication with PC 300, based on the received IP address of the terminal device. Furthermore, CPU 10 transmits the received change information and identification information of MFP 200 belonging to the sub-group to PC 300.

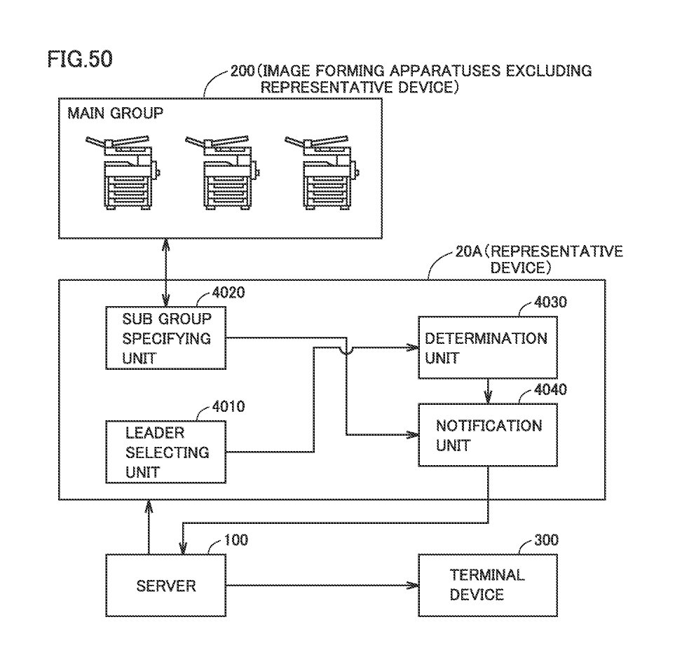

FIG. 50 is a block diagram for explaining a functional configuration of information processing system 1 according to an embodiment. This functional configuration of information processing system 1 is almost the same as the functional configuration described in FIG. 40 and only the differences will be described.

Notification unit 4040 transmits the change information and the identification information (for example, IP address) of MFP 200 belonging to the sub-group to server 100. Server 100 transmits the received information to PC 300.

In this way, information processing system 1 according to an embodiment adopts a configuration in which transmission from MFP 200 to PC 300 is via server 100. This information processing system 1 can suppress a network traffic increase, compared with information processing system 1X according to a related art.

In an embodiment, a program is provided to allow a variety of information processing devices to execute the processes in the foregoing flowcharts. The program is executed to allow the existing device such as MFP 200, server 100, and PC 300 to execute the processes above and to construct the information processing system according to the present embodiment.

Such a program may be provided as a program product stored in a computer-readable recording medium such as flexible disc, CD-ROM (Compact Disk-Read Only Memory), ROM, RAM, and memory card attached to the computer of the existing device. Alternatively, the program may be stored in a recording medium such as hard disk contained in the computer. Alternatively, the program may be downloaded through a network.

The program according to an embodiment may invoke and execute necessary modules in a predetermined sequence and at a predetermined timing, among program modules provided as part of an operating system (OS) of the computer. In this case, the program does not include the modules per se, and the process is executed in cooperation with the OS. Such a program that does not include modules may be included in the program described above.

The program according to an embodiment may be built in part of another program. Also in this case, the program per se does not include the modules included in another program, and the process is executed in cooperation with another program. Such a program built in another program may be included in the program described above.

The program product provided is installed into a program storage unit such as hard disk for execution. The program product includes the program per se and a recording medium having the program stored therein.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming apparatus comprising:
a processor for controlling the image forming apparatus;
a storage device for storing setting information set for the image forming apparatus; and
a communication device for communicating with one or more external devices, wherein;
the external devices include a terminal device having an application performing collaborative operation with the image forming apparatus in accordance with collaboration information that matches the setting information, and
when the setting information is changed, the processor determines whether to transmit a change notice indicating that the setting information has been changed to the terminal device.

2. The image forming apparatus according to claim 1, wherein the processor is configured to determine to transmit the change notice when at least part of the collaboration information received from the terminal device does not match the changed setting information.

3. The image forming apparatus according to claim 1, wherein the processor is configured to determine whether to transmit the change notice, based on history of communication between the terminal device and the image forming apparatus for the collaborative operation by the application.

4. The image forming apparatus according to claim 3, wherein
the processor is configured to determine to transmit the change notice when the image forming apparatus communicates with the terminal device for the collaborative operation by the application within a predetermined time since the setting information is changed.

5. The image forming apparatus according to claim 1, wherein the processor is configured such that the collaboration information of the terminal device is matched with information after change that is the changed setting information, when the change notice is transmitted to the terminal device.

6. The image forming apparatus according to claim 5, wherein the processor is configured to allow the terminal device to perform a matching process of matching the collaboration information with the information after change, when the change notice is transmitted to the terminal device.

7. The image forming apparatus according to claim 6, wherein the processor is further configured to transmit the information after change to the terminal device in order to allow the terminal device to perform the matching process, when the change notice is transmitted to the terminal device.

8. The image forming apparatus according to claim 7, wherein
the external devices include an information processing device capable of communicating with the terminal device, and
the processor is configured to:
change the setting information using information for change and
transmit the information for change to the application in order to allow the terminal device to perform the matching process.

9. The image forming apparatus according to claim 8, wherein the processor is configured to request the information processing device to transmit the information for change to the terminal device in order to allow the terminal device to perform the matching process.

10. The image forming apparatus according to claim 8, wherein the processor is configured to request the information processing device to transmit the change notice to the terminal device.

11. A terminal device that communicates with an image forming apparatus,
the terminal device comprising:
a processor that controls the terminal device;
a storage device for storing collaboration information that matches setting information set in the image forming apparatus; and
an application that performs collaborative operation with the image forming apparatus in accordance with the collaboration information,
wherein the processor is configured to match the collaboration information with the setting information after change, when receiving a change notice indicating that the setting information has been changed from the image forming apparatus.

12. An information processing device that communicates with a terminal device,
the information processing device comprising a processor that controls the information processing device, wherein
the terminal device has an application configured to operate in collaboration with an image forming apparatus in accordance with collaboration information that matches setting information set for the image forming apparatus, and
the processor is configured to transmit information for change for matching the collaboration information with the setting information after change to the terminal device when the setting information of the image forming apparatus is changed.

13. An information processing system comprising:
an image forming apparatus; and
a terminal device that communicates with the image forming apparatus,
the image forming apparatus including:
a processor for controlling the image forming apparatus; and
a storage device for storing setting information set for the image forming apparatus, the terminal device including an application that performs collaborative operation with the image forming apparatus in accordance with collaboration information that matches the setting information,
wherein the processor of the image forming apparatus is configured to determine whether to transmit a change notice indicating that the setting information has been changed to the terminal device, when the setting information is changed.

14. An image forming apparatus included in a plurality of image forming apparatuses configured to have settings changed in accordance with an instruction from an external device,
the image forming apparatus comprising:
a processor for controlling the image forming apparatus;
a storage device for storing setting information set for the image forming apparatus; and
a communication interface for communicating with a terminal device and the external device, wherein
the processor is configured to:
operate in accordance with an instruction from the terminal device,
acquire identification information of the plurality of image forming apparatuses,
determine whether the image forming apparatus is a representative of the plurality of image forming apparatuses, and
when the image forming apparatus is determined to be the representative, transmit identification information of the plurality of image forming apparatuses and change information indicating a changed content in the setting information to the terminal device.

15. The image forming apparatus according to claim 14, wherein the processor is configured to determine whether the image forming apparatus is the representative, based on the identification information of each of the plurality of image forming apparatuses.

16. The image forming apparatus according to claim 15, wherein the identification information includes at least one of IP (Internet Protocol) address and MAC (Media Access Control) address.

17. The image forming apparatus according to claim 14, wherein the processor is configured to determine whether the image forming apparatus is the representative, based on history of communication between each of the plurality of image forming apparatuses and the terminal device.

18. The image forming apparatus according to claim 17, wherein the processor is configured to determine whether the image forming apparatus is the representative, based on frequency of communication between each of the plurality of image forming apparatuses and the terminal device.

19. The image forming apparatus according to claim 17, wherein the processor is configured to determine whether the image forming apparatus is the representative, based on the number of times of communication between each of the plurality of image forming apparatuses and the terminal device.

20. The image forming apparatus according to claim 17, wherein the processor is configured to determine whether the image forming apparatus is the representative, based on date and time of communication between each of the plurality of image forming apparatuses and the terminal device.

21. The image forming apparatus according to claim 14, wherein the processor is configured to determine whether the image forming apparatus is the representative, based on quality of communication between each of the plurality of image forming apparatuses and the terminal device.

22. The image forming apparatus according to claim 14, wherein the processor is configured to determine whether the image forming apparatus is the representative, based on device model information of each of the plurality of image forming apparatuses.

23. The image forming apparatus according to claim 14, wherein the processor is configured to determine whether the image forming apparatus is the representative, based on version information of firmware of each of the plurality of image forming apparatuses.

24. The image forming apparatus according to claim 14, wherein the processor is configured to determine whether the image forming apparatus is the representative, based on operating rate of each of the plurality of image forming apparatuses.

25. The image forming apparatus according to claim 14, wherein the processor is configured to determine whether the image forming apparatus is the representative, based on failure rate of each of the plurality of image forming apparatuses.

26. The image forming apparatus according to claim 14, wherein
the processor is configured to determine whether the image forming apparatus is the representative, based on information received from another image forming apparatus different from the image forming apparatus, of the plurality of image forming apparatuses, and
the information received from the other image forming apparatus is information that specifies an image forming apparatus serving as the representative of the plurality of image forming apparatuses.

27. The image forming apparatus according to claim 14, wherein
the processor is configured to determine whether the image forming apparatus is the representative, based on information received from the external device, and
the information received from the external device is information that specifies an image forming apparatus serving as the representative of the plurality of image forming apparatuses.

28. An information processing system comprising:
a plurality of image forming apparatuses configured to have settings changed in accordance with an instruction from an external device; and
a terminal device configured to communicate with at least one or more image forming apparatuses of the plurality of image forming apparatuses, wherein
a predetermined image forming apparatus of the one or more image forming apparatuses selects a representative device from among the plurality of image forming apparatuses,
the representative device is configured to:
acquire identification information of the plurality of image forming apparatuses, and
transmit the identification information of the plurality of image forming apparatuses and change information indicating a content changed in accordance with an instruction from the external device to the terminal device, and
the predetermined image forming apparatus is configured to select a new representative device different from the representative device from among the plurality of image forming apparatuses when the representative device fails to transmit the change information and the identification information to the terminal device.

29. An information processing system comprising:
a plurality of image forming apparatuses configured to have settings changed in accordance with an instruction from an external device; and
a terminal device configured to collaborate with one or more image forming apparatuses of the plurality of image forming apparatuses, wherein
the information processing system is configured to:
determine whether to transmit a change notice indicating that the settings have been changed to the terminal device when the settings of an image forming apparatus are changed in accordance with an instruction from the external device,
specify a sub-group including two or more image forming apparatuses in accordance with a predetermined condition, from a main group including image forming apparatuses subjected to a same setting change in accordance with an instruction from the external device, of the plurality of image forming apparatuses, and
when it is determined to transmit the change notice to the terminal device, transmit the change notice or change information indicating a content of the changed settings from the image forming apparatus belonging to the sub-group to the terminal device.

30. The information processing system according to claim 29, wherein the information processing system is configured to specify an image forming apparatus communicating with the terminal device, as an image forming apparatus belonging to the sub-group, among a plurality of image forming apparatuses belonging to the main group.

31. The information processing system according to claim 30, wherein the information processing system is configured to specify an image forming apparatus communicating with the terminal device within a predetermined period, as an image forming apparatus belonging to the sub-group.

32. The information processing system according to claim 29, wherein the information processing system is configured to specify an image forming apparatus belonging to the sub-group, based on information of at least one of installation location and network segment of a plurality of image forming apparatuses belonging to the main group.

33. The information processing system according to claim 29, wherein
one image forming apparatus of a plurality of image forming apparatuses belonging to the main group is configured to specify an image forming apparatus belonging to the sub-group, and
the one image forming apparatus is configured to transmit information of an image forming apparatus belonging to the sub-group to the specified image forming apparatus belonging to the sub-group.

34. The information processing system according to claim 29, wherein
the information processing system is configured to select a representative device from among the image forming apparatuses belonging to the sub-group,
the representative device acquires identification information of the image forming apparatuses belonging to the sub-group, and
the information processing system is configured such that the change notice, or the change information and the identification information of the image forming apparatuses belonging to the sub-group are transmitted from the representative device to the terminal device.

35. The information processing system according to claim 34, wherein
the information processing system is configured such that the change notice, or the change information and the identification information of the image forming apparatuses belonging to the sub-group are transmitted from the representative device to the terminal device via the external device.

36. The information processing system according to claim 34, wherein
the image forming apparatus includes an input device for accepting operation by a user, and
the information processing system is configured to select the representative device at at least one of: timing when the sub-group is specified; timing when the terminal device accesses any one of a plurality of image forming apparatuses belonging to the sub-group; and timing when the user executes a predetermined process on the input device.

37. The information processing system according to claim 34, wherein
the image forming apparatus selected as the representative device is configured to notify each of a plurality of image forming apparatuses belonging to the sub-group that the image forming apparatus is a representative device, and
each of a plurality of image forming apparatuses belonging to the sub-group is configured to, in response to being accessed from the terminal device, transmit an access notice indicating access from the terminal device to the representative device.

38. The information processing system according to claim 37, wherein each of a plurality of image forming apparatuses belonging to the sub-group is configured to, in response to being accessed from the terminal device in accordance with the settings before change, transmit the access notice to the representative device.

39. The information processing system according to claim 37, wherein the representative device is configured to, in response to reception of the access notice, transmit the change notice, or the change information and the identification information of the image forming apparatuses belonging to the sub-group to the terminal device.

40. The information processing system according to claim 34, wherein the representative device is configured to transmit, to each of image forming apparatuses belonging to the sub-group, a notice indicating that the change notice, or the change information and the identification information of the image forming apparatuses belonging to the sub-group have been transmitted to the terminal device.

41. The information processing system according to claim 29, wherein
the information processing system selects a representative device from among the image forming apparatuses belonging to the sub-group, and
each of a plurality of image forming apparatuses belonging to the sub-group is configured to transmit the change notice, or the change information and the identification information of the image forming apparatuses belonging to the sub-group to the terminal device, based on an instruction from the representative device.

42. The information processing system according to claim 29, wherein each of a plurality of image forming apparatuses belonging to the sub-group is configured to transmit the change notice, or the change information and the identification information of the image forming apparatuses belonging to the sub-group to the terminal device, based on an instruction from the external device.

43. An image forming apparatus configured to be able to collaborate with a terminal device, the image forming apparatus comprising:
a communication interface for communicating with an external device and other image forming apparatuses configured to have settings changed in accordance with an instruction from the external device;
a storage device for storing setting information set for the image forming apparatus; and
a processor that controls communication with the terminal device,
wherein the processor is configured to:
specify a sub-group including at least two or more image forming apparatuses from a main group including image forming apparatuses subjected to a same change to setting information in accordance with an instruction from the external device, from among the other image forming apparatuses,
when the setting information is changed in accordance with an instruction from the external device, determine whether to transmit a change notice indicating that the setting information has been changed to the terminal device, and
when it is determined to transmit the change notice to the terminal device, transmit the change notice or change information indicating a content of the changed setting information to the terminal device.
